(19) United States
(12) Patent Application Publication
(10) Pub. No.: US 2018/0305483 A1
(43) Pub. Date: Oct. 25, 2018

(54) FUNCTIONALIZED FLUORINATED COPOLYMERS

(71) Applicants: Arkema France, Colombes (FR); Centre National de la Recherche Scientifique, Paris (FR); Universite de Montpellier, Montpellier (FR); Ecole Nationale Superieure de Chimie de Montpellier, Montpellie34296 (FR)

(72) Inventors: Thierry T. LANNUZEL, Villeurbanne (FR); Bruno AMEDURI, Montpellier (FR); Ali ALAAEDDINE, Hadath-Beyrouth-Liban (LB)

(21) Appl. No.: 15/769,263

(22) PCT Filed: Oct. 18, 2016
(86) PCT No.: PCT/FR2016/052686

§ 371 Date: Apr. 18, 2018

(30) Foreign Application Priority Data
Oct. 19, 2015 (FR) 1559945

(51) Int. Cl. C08F 214/22; C08F 2/38; C08K 5/541; C08K 5/372; C08K 5/136; C08K 5/3492; C08K 5/02; C08L 27/22

(52) U.S. Cl. CPC C08F 214/22; C08F 2/38; C08K 5/541; C08L 27/22; C08K 5/136; C08K 5/34922; C08K 5/02; C08K 5/372

(57) ABSTRACT

The invention relates to a fluorinated copolymer including: one or more polymer chains including vinyl fluoride and tetrafluropropene units, and one or more terminal functional groups comprising at least one alcohol, acetate, vinyl, azide, amine, carboxylic acid, (meth)acrylate, expoxide, cyclocarbonate, alkoxysilane, of vinyl ether function. The invention also relates to a method for preparing same.

### FIELD OF THE INVENTION

The present invention relates to functional fluoro copolymers obtained from vinylidene fluoride (VDF) and tetrafluoropropene monomers, and also to processes for preparing these polymers.

### TECHNICAL BACKGROUND

Fluoropolymers represent a class of compounds with noteworthy properties for a large number of applications, from paints or special coatings to sealing joints, via optics, microelectronics, separators, electrode binders and electrolytes for lithium ion batteries, and membrane technology. Among these fluoropolymers, vinylidene fluoride-based copolymers are particularly advantageous due to their diversity, their morphology, their exceptional properties and their versatility.

U.S. Pat. No. 3,085,996 describes the preparation of copolymers based on 2,3,3,3-tetrafluoropropene (1234yf) and VDF or various other fluoro monomers, via an aqueous emulsion polymerization process.

WO 2008/079986 describes a copolymer based on VDF and a fluoroolefin chosen from 2,3,3,3-tetrafluoropropene, 1,1,3,3,3-pentafluoropropene, 2-chloropentafluoropropene, hexafluoropropene, trifluoroethylene, chlorotrifluoroethylene and 3,3,3-trifluoro-2-trifluoromethylpropene. In particular, an example is given of an emulsion copolymerization reaction of VDF and 1234yf.

WO 2013/160621 describes the manufacture of copolymers by controlled radical copolymerization, based on trifluoroethylene (TrFE). In particular, the synthesis of a block polymer comprising a PVDF block and a terpolymer block based on VDF, TrFE and 1234yf, with an iodo or xanthate end group, is described; the synthesis of a block polymer comprising a copolymer block of VDF and of TrFE and a terpolymer block based on VDF, TrFE and 1234yf is also described.

The article by Boyer et al. in Macromolecules, 43:3652-3663 (2010) describes the manufacture of copolymers based on VDF and PMVE by iodine-transfer radical copolymerization. Monoiodo and diiodo chain-transfer agents are proposed, namely C₆F₁₃I, IC₆F₁₂I and IC₄F₈I. The copolymers thus obtained bear iodo end groups.

The article by Kostov et al. in Macromolecules, 45:7375-7387 (2012) describes the preparation of diiodo copolymers of VDF and of perfluoromethyl vinyl ether (PMVE), and also the preparation of diacrylate copolymers therefrom.

US 2011/00153358 and US 2011/00153359 describe copolymers bearing diacrylate end groups, composed of VDF and PMVE, or VDF and hexafluoropropene (HFP), or tetrafluoroethylene (TFE) and PMVE, or TFE and ethylene or propylene units. The document also describes the use of these copolymers for the formation of a crosslinked fluoropolymer network.

U.S. Pat. No. 8,138,274 relates to a process for preparing a crosslinked fluoropolymer from an iodo oligomer and a vinyl silane compound.

U.S. Pat. No. 8,288,492 describes difunctional copolymers based on VDF or TFE and PMVE (and optionally HFP and a fluorovinyl ether) units. The end functions may be iodine atoms or olefin, hydroxyl, carboxylic or —CF₂H groups.

However, there is still a need to develop novel fluoro copolymers. There is most particularly a need to develop novel functionalized fluoro copolymers, making it possible to implement subsequent reactions, for example chain extension (for block copolymers), grafting or crosslinking reactions.

### SUMMARY OF THE INVENTION

The invention relates first to a copolymer comprising:
one or more polymer chains comprising vinylidene fluoride and tetrafluoropropene units; and
one or more functional end groups comprising at least one alcohol, acetate, vinyl, azide, amine, carboxylic acid, (meth)acrylate, epoxide, cyclocarbonate, alkoxysilane or vinyl ether function.

According to one embodiment, said polymer chains comprise vinylidene fluoride and 2,3,3,3-tetrafluoropropene units.

According to one embodiment, said polymer chains are statistical polymer chains.

According to one embodiment, each said polymer chain has a number-average molar mass of from 500 to 300 000 g/mol, preferably from 1000 to 100 000 g/mol and more particularly preferably from 2000 to 50 000 g/mol.

According to one embodiment, the functional end group(s) are chosen from:
—CH₂—CHI—CH₂—OH,
—CH₂—CHI—CH₂—OAc, in which OAc represents an acetate function,
—CH₂—CH₂—(CH₂)ₘ—OH, in which m is an integer from 0 to 10,
—CH₂—CH₂—(CH₂)ₘ—O—C(═O)—CH═CH₂ in which m is an integer from 0 to 9,
—CH₂—CH₂—(CH₂)ₘ—O—C(═O)—C(CH₃)═CH₂, in which m is an integer from 0 to 9,
—CH₂—CH₂—N₃,
—CH₂—CH₂—NH₂,
—CH₂—COOH,
—(CH₂)—CH═CH₂,
—O—CH═CH₂,
—Si(OR)ₓ(CH₃)₃₋ₓ, x being an integer from 1 to 3, and each R independently representing an alkyl group comprising from 1 to 10 carbon atoms;
—O—CH₂-epoxide; and
—O—CH₂-cyclocarbonate.

According to one embodiment, the copolymer is a linear copolymer of formula (I) R_{f}¹-A-X, in which X is a “functional end group”, A is a “polymer chain” and R_{f}¹ represents a halogenated end group.

According to one embodiment, Rf¹ represents a fluoro alkyl chain F—(CF₂)₂ₙ, n representing an integer from 1 to 6.

According to an alternative embodiment, the copolymer is a linear copolymer of formula (II) X-A-R_{f}²-A′-X, in which each X represents a “functional end group”, A and A′ each represent a “polymer chain” and R² represents a halogenated bonding group.

According to one embodiment, Rf² represents a fluoro alkylene chain (CF₂)₂ₙ, n representing an integer from 1 to 6.

According to one embodiment, Rf² represents B—R_{f}′—B′, with R_{f}′ a fluoro alkylene chain (CF₂)₂ₙ, n representing an integer from 1 to 6, and B and B′ each representing a copolymer chain composed of halogenated units.

According to one embodiment, B and B′ each represent a copolymer chain composed of halogenated units derived from one or more monomers of formula CY₁Y₂═CY₃Y₄, in which Y₁, Y₂, Y₃ and Y₄ are chosen from H, F, Cl, Br, CF₃, C₂F₅ and C₃F₇, at least one of them being a fluorine atom.

According to one embodiment, B and B′ each represent a polymer chain composed of units chosen from units derived from vinylidene fluoride, trifluoroethylene, tetrafluoroethylene, 2,3,3,3-tetrafluoropropene, vinyl fluoride, 2-chloro-1,1-difluoroethylene, chlorofluoro-1,1-ethylene, chlorofluoro-1,2-ethylene, chlorotrifluoroethylene, 2-bromo-1,1-difluoroethylene, hexafluoropropene, 3,3,3-trifluoropropene, 3,3,3-trifluoro-2-chloropropene, 1,3,3,3-tetrafluoropropene, 3,3,3-trifluoro-2-bromopropene, 1H-pentafluoropropene, 3,3,3-trifluoro-1-chloropropene, bromotrifluoroethylene and 2H-pentafluoropropene monomers.

According to one embodiment, B and B′ each have a number-average molar mass of from 500 to 300 000 g/mol, preferably from 1000 to 100 000 g/mol and more particularly preferably from 2000 to 50 000 g/mol.

According to an alternative embodiment, the copolymer is a star copolymer of formula:

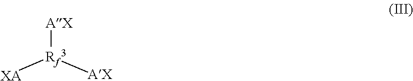

in which each X represents a “functional end group”, A, A′ and A″ each represent a “polymer chain”, and R_{f}³ represents a halogenated bonding group.

According to one embodiment, the copolymer is a copolymer having one of the formulae (IIIa) to (IIIh):

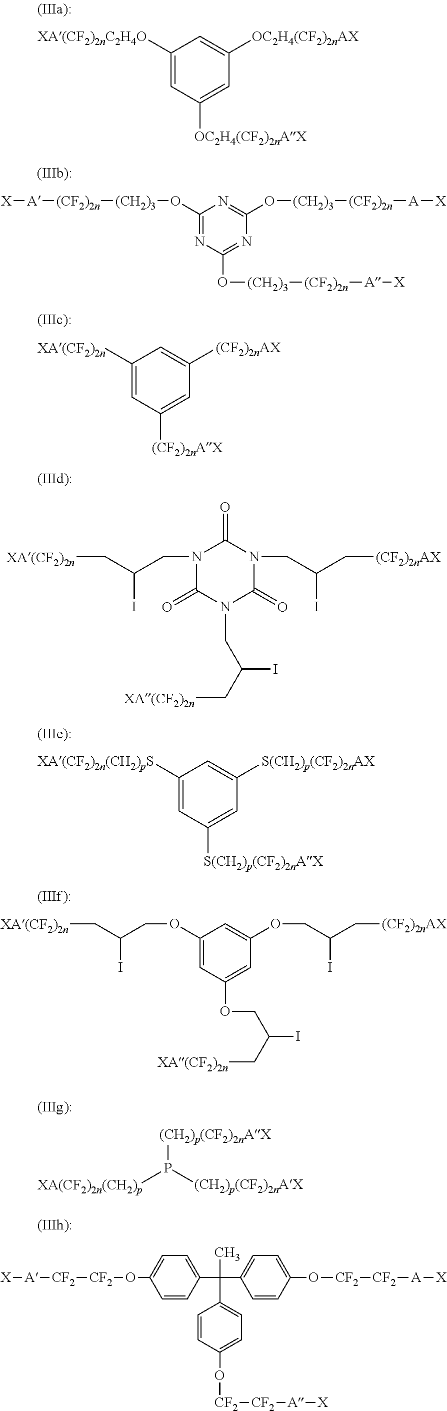

in which n is an integer from 1 to 6 and p is an integer equal to 1 or 2.

According to an alternative embodiment, the copolymer is a star copolymer of formula:

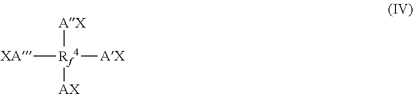

in which each X represents a “functional end group”, A, A′, A″ and A′″ each represent a “polymer chain”, and R_{f}⁴ represents a halogenated bonding group.

According to one embodiment, the copolymer is a copolymer having one of the following formulae:

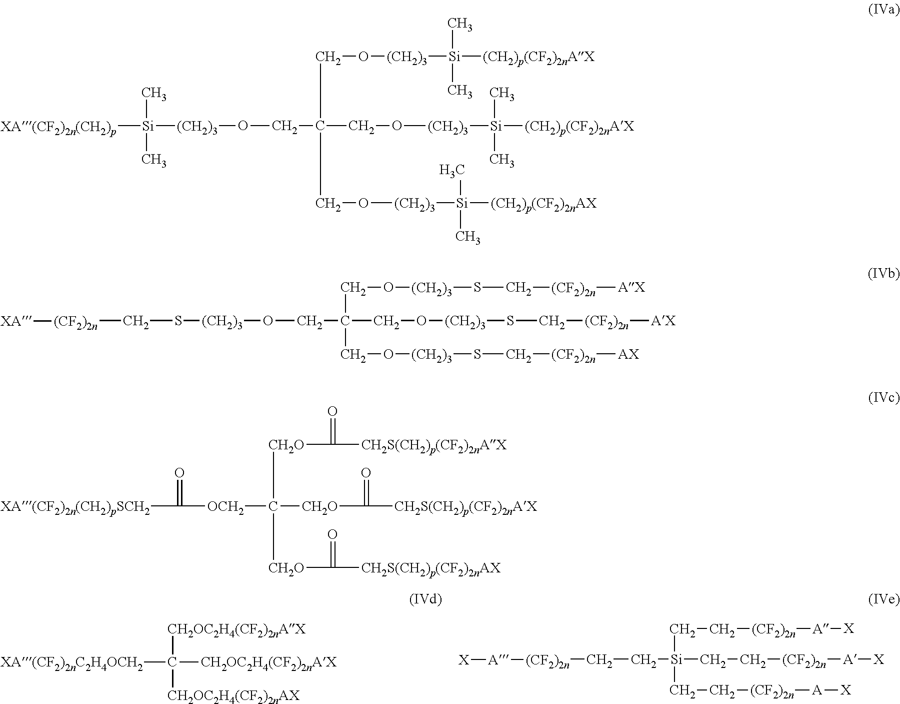

The invention also relates to a process for preparing a copolymer according to the invention, comprising:
a step of providing a copolymer comprising one or more polymer chains comprising vinylidene fluoride and tetrafluoropropene units, and also one or more iodo end groups; and
a step of functionalizing one or more of said iodo end groups.

According to one embodiment, said provision step comprises a step of controlled radical copolymerization of a vinylidene fluoride monomer and of a tetrafluoropropene monomer, in the presence of an initiator and of an iodo compound as chain-transfer agent.

According to one embodiment, the chain-transfer agent is chosen from the compounds of formulae:
F—(CF₂)₂ₙ—I,
CH₂═CH—(CF₂)₂ₙ—I,
CH₂═CH—CH₂—(CF₂)₂ₙ—I,
I—CH₂—CH₂—(CF₂)₂ₙ—I,
I—(CF₂)₂ₙ—I,
I—B—(CF₂)₂ₙ—B′—I, B and B′ each representing a copolymer chain composed of halogenated units, preferably a copolymer chain composed of two halogenated units derived from one or more monomers of formula CY₁Y₂═CY₃Y₄, in which Y₁, Y₂, Y₃ and Y₄ are chosen from H, F, Cl, Br, CF₃, C₂F₅ and C₃F₇, at least one of them being a fluorine atom, and even more preferably a polymer chain composed of units chosen from vinylidene fluoride, trifluoroethylene, tetrafluoroethylene, 2,3,3,3-tetrafluoropropene, vinyl fluoride, 2-chloro-1,1-difluoroethylene, 2-bromo-1,1-difluoroethylene, hexafluoropropene, 3,3,3-trifluoropropene, 3,3,3-trifluoro-2-chloropropene, 1,3,3,3-tetrafluoropropene, 3,3,3-trifluoro-1-chloropropene, bromotrifluoroethylene, 3,3,3-trifluoro-2-bromopropene, 1H-pentafluoropropene and 2H-pentafluoropropene units,
the compound of formula (IIIa′):

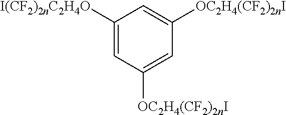

the compound of formula (IIIb′):

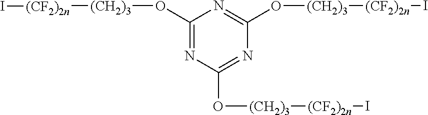

the compound of formula (IIIc′):

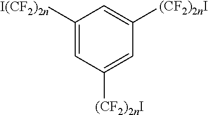

the compound of formula (IIId′):

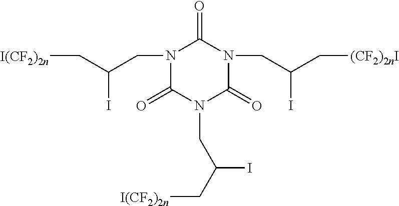

the compound of formula (IIIe′):

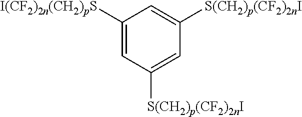

the compound of formula (IIIf′):

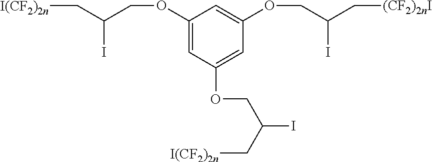

the compound of formula (IIIg′):

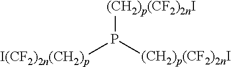

the compound of formula (IIIh′):

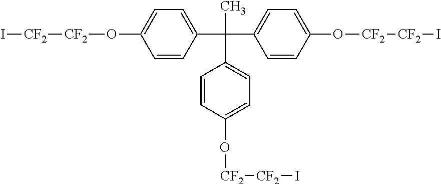

the compound of formula (IVa′):

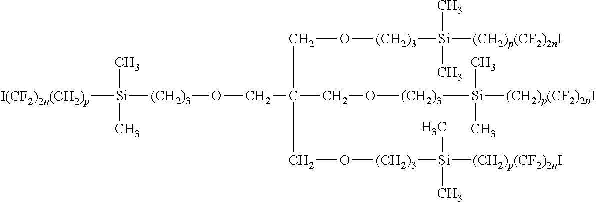

the compound of formula (IVb′):

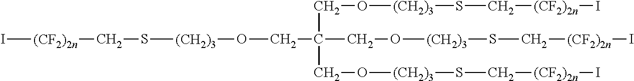

the compound of formula (IVc′):

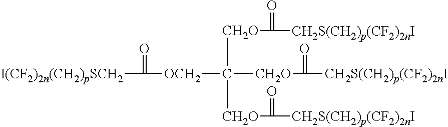

the compound of formula (IVd′):

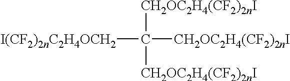

the compound of formula (IVe′):

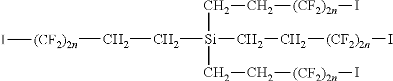

in which n represents an integer from 1 to 6 and p represents an integer equal to 2 or 3.

The present invention meets the needs expressed above. It more particularly provides novel fluoro copolymers obtained by controlled radical copolymerization, which are functionalized and thus make it possible to implement subsequent reactions, for example chain extension (for block copolymers), grafting or crosslinking reactions.

### BRIEF DESCRIPTION OF THE FIGURES

FIG. 1 represents the ¹⁹F NMR spectrum of an example of diiodo poly(VDF-co-1234yf) copolymer according to the invention (see example 2).

FIG. 2 represents the IR spectrum of an example of diiodo poly(VDF-co-1234yf) copolymer according to the invention (see example 2). The wavelength in cm⁻¹ is represented on the x-axis and the % transmittance is represented on the y-axis.

FIG. 3 represents the ¹H NMR spectrum of an example of poly(VDF-co-1234yf) diol copolymer according to the invention (see example 3).

FIG. 4 represents the ¹⁹F NMR spectrum of an example of poly(VDF-co-1234yf) diol copolymer according to the invention (see example 3).

FIG. 5 represents the IR spectrum of an example of poly(VDF-co-1234yf) diol copolymer according to the invention (see example 3). The wavelength in cm⁻¹ is represented on the x-axis and the % transmittance is represented on the y-axis.

### DESCRIPTION OF EMBODIMENTS OF THE INVENTION

The invention is now described in greater detail and in a nonlimiting manner in the description which follows.

All the percentages indicated correspond to molar contents or percentages, unless otherwise mentioned.

### General Structure of the Copolymers

The copolymers according to the invention comprise one or more polymer chains comprising vinylidene fluoride (VDF) and tetrafluoropropene units, bearing one or more functionalized end groups.

The term “unit” means a unit derived from the polymerization of a VDF or tetrafluoropropene monomer, respectively. Preferably, said polymer chains consist of VDF and tetrafluoropropene units. However, in an alternative embodiment, the presence of at least one additional unit, preferably derived from an additional hydrohaloolefin monomer, such as a hydrofluoroolefin, hydrochloroolefin, hydrobromoolefin or hydrofluorochloroolefin monomer, may be envisaged.

By way of example, said at least one additional unit may be chosen from units derived from trifluoroethylene, tetrafluoroethylene, vinyl fluoride, 2-chloro-1,1-difluoroethylene, chlorofluoro-1,1-ethylene, chlorofluoro-1,2-ethylene, chlorotrifluoroethylene 2-bromo-1,1-difluoroethylene, hexafluoropropene, 3,3,3-trifluoropropene, 3,3,3-trifluoro-2-chloropropene, 3,3,3-trifluoro-1-chloropropene, bromotrifluoroethylene, 3,3,3-trifluoro-2-bromopropene, 1H-pentafluoropropene and 2H-pentafluoropropene monomers.

The tetrafluoropropene units are preferably 1234yf units (i.e. units derived from the 2,3,3,3-tetrafluoropropene or 1234yf monomer). However, alternatively, it may be envisaged for these units to be derived from one or more other tetrafluoropropene isomers, and especially 1234ze (unit derived from the 1,3,3,3-tetrafluoropropene or 1234ze monomer) in cis form or, preferably, in trans form. Mixtures of tetrafluoropropene units derived from various isomers may also be used.

The copolymers according to the invention may be manufactured via a preparation process in at least two steps:
a step of controlled radical copolymerization of VDF and of tetrafluoropropene monomers (and optionally of the additional monomers), in the presence of an initiator and of a chain-transfer agent; and
a functionalization step.

According to a preferential embodiment, the chain-transfer agent is an iodo compound, in which case the controlled radical copolymerization step is an ITP (Iodine Transfer Polymerization) step.

Depending on the number of iodo end groups in the iodo compound that are capable of leading to an iodine transfer reaction, various types of copolymers are obtained. In the text hereinbelow, examples of monoiodo, diiodo, triiodo and tetraiodo compounds are given in particular, i.e. compounds which comprise, respectively, one, two, three or four iodo end groups capable of leading to an iodine transfer polymerization reaction.

### Use of a Monoiodo Chain-Transfer Agent

A monoiodo chain-transfer agent is of general formula:

R_{f}¹—I (I′)

in which R_{f}¹ represents a halogenated end group. Preferably, R_{f}¹ is a fluoro group. On conclusion of the controlled radical copolymerization step, a copolymer is then obtained having the general formula:

R_{f}¹-A-I (I″)

in which R_{f}¹ has the same meaning as above and A represents a polymer chain comprising VDF and tetrafluoropropene units, as defined above.

This copolymer is then subjected to the functionalization step, which gives the copolymer of general formula:

R_{f}¹-A-X (I)

in which R_{f}¹ and A have the same meaning as above, and X represents a functional end group, as described in greater detail hereinbelow.

According to a particular embodiment, the group R_{f}¹ represents a partially or totally fluorinated alkyl chain.

Thus, it is known practice to provide monoiodo compounds of formula (CF₂)₂ₙ—I in which n is an integer equal to 1 or 2 or 3 or 4 or 5 or 6. These compounds are commercially available.

It is also possible to provide a monoiodo compound of formula CH₂═CH—(CF₂)₂ₙ—I in which n is an integer equal to 1 or 2 or 3 or 4 or 5 or 6. This compound may be prepared in the following manner:
provision of the diiodo compound of formula I—(CF₂)₂ₙ—I;
reaction of this compound with ethylene, to give the compound of formula I—CH₂—CH₂—(CF₂)₂ₙ—I;
reaction of this compound in the presence of potassium or sodium hydroxide, to give the compound CH₂═CH—(CF₂)₂ₙ—I.

The first reaction may be performed, for example, as follows: in a reactor under pressure equipped with inlet and outlet valves, a manometer, a stirring anchor and a rupture disk, the reagents (I—(CF₂)₂ₙ—I, tert-butanol and biscyclohexyl peroxydicarbonate) may be introduced, and, after three vacuum/nitrogen cycles, the reactor may then be cooled to −80° C., followed by transferring the ethylene therein (in equimolar proportion with the I—(CF₂)₂ₙ—I). The reaction may last 8-10 hours at 60° C. with an increase in pressure gradually as the reactor is heated, followed by a drop associated with the consumption of ethylene; the diiodo derivative obtained may be distilled off. It may be characterized by ¹H and ¹⁹F NMR spectroscopy. This first reaction is described in detail in the article by Barthélémy et al., in Org. Lett. 1:1689-1692 (2000).

The second reaction may, for example, be performed as follows: I—CH₂—CH₂—(CF₂)₂ₙ—I dissolved in methanol may be introduced into a two-necked round-bottomed flask equipped with a condenser. A solution of sodium hydroxide diluted in methanol may be added dropwise at room temperature, and the mixture is then heated at 60° C. for 2 hours. After evaporating off the solvent, the compound CH₂═CH—(CF₂)₂ₙ—I may be distilled off.

It is also possible to provide a monoiodo compound of formula CH₂═CH—CH₂—(CF₂)₂ₙ—I in which n is an integer equal to 1 or 2 or 3 or 4 or 5 or 6. This compound may be prepared in the following manner:
provision of the diiodo compound of formula I—(CF₂)₂ₙ—I;
reaction of this compound with allyl acetate, to give the monofunctional compound of formula AcO—CH₂—CHI—CH₂—(CF₂)₂ₙ—I in which AcO represents an acetate group;
reaction of this compound in the presence of zinc, to give the compound CH₂═CH—CH₂—(CF₂)₂ₙ—I.

The first reaction is described, for example, in the publications from Cirkva et al., in J. Fluorine Chem., 74:97-105 (1995), from Améduri et al., in J. Fluorine Chem., 74:191-197 (1995), from Guyot et al. in J. Fluorine Chem., 74:233-240 (1995) and from Manseri et al. in J. Fluorine Chem., 73:151-158 (1995).

The second reaction may be performed, for example, as follows: zinc (activated by ultrasonication or with a catalytic amount of bromine or of acetic acid/acetic anhydride in methanol) may be first introduced into a two-necked round-bottomed flask into which may be added dropwise the compound AcO—CH₂—CHI—CH₂—(CF₂)₂ₙ—I in an equimolar amount (relative to the zinc) in methanol. After reaction, the reaction medium may be maintained at the boiling point of methanol for 4 hours.

Thus, on conclusion of the controlled radical copolymerization step, the copolymers corresponding to the following formulae may in particular be obtained:
(Ia″) F(CF₂)₂ₙ-A-I, in which n is 1, or 2, or 3, or 4, or 5, or 6, and A has the above meaning;
(Ib″) CH₂═CH—(CF₂)₂ₙ-A-I, in which n is 1, or 2, or 3, or 4, or 5, or 6, and A has the above meaning;
(Ic″) CH₂═CH—CH₂—(CF₂)₂ₙ-A-I, in which n is 1, or 2, or 3, or 4, or 5, or 6, and A has the above meaning.

Following the functionalization step, the copolymers corresponding to the following formulae are in particular obtained:
(Ia) F(CF₂)₂ₙ-A-X, in which n is 1, or 2, or 3, or 4, or 5, or 6, and A has the above meaning;
(Ib) CH₂═CH—(CF₂)₂ₙ-A-X, in which n is 1, or 2, or 3, or 4, or 5, or 6, and A has the above meaning;
(Ic) CH₂═CH—CH₂—(CF₂)₂ₙ-A-X, in which n is 1, or 2, or 3, or 4, or 5, or 6, and A has the above meaning.

### Use of a Diiodo Chain-Transfer Agent

A diiodo chain-transfer agent is of general formula:

I—R_{f}²—I (II′)

in which R_{f}² represents a halogenated bonding group. Preferably, R_{f}² is a fluoro group. On conclusion of the controlled radical copolymerization step, a copolymer is then obtained having the general formula:

I-A-R_{f}²-A′-I (II″)

in which R_{f}² has the same meaning as above and A and A′ each represent a polymer chain comprising VDF and 1234 units, as defined above.

This copolymer is then subjected to the functionalization step, which gives the copolymer of general formula:

X-A-R_{f}²-A′-X (II)

in which R_{f}², A and A′ have the same meaning as above, and X represents a functional end group, as described in greater detail hereinbelow.

According to a particular embodiment, the group R_{f}² represents a partially or totally fluorinated alkylene chain.

Thus, it is known practice to provide diiodo compounds of formula:

I—(CF₂)₂ₙ—I, (IIa′)

in which n is an integer equal to 1 or 2 or 3 or 4 or 5 or 6.

Thus, on conclusion of the controlled radical copolymerization step, the copolymer is obtained having the formula:

I-A-(CF₂)₂ₙ-A′-I, (IIa″)

in which n is 1, or 2, or 3, or 4, or 5, or 6, and A and A′ have the above meaning.

Next, following the functionalization step, the copolymer is obtained of formula:

X-A-(CF₂)₂ₙ-A′-X, (IIa)

in which n is 1, or 2, or 3, or 4, or 5, or 6, and A and A′ have the above meaning.

Moreover, it is possible to envisage a preliminary step of polymerization or copolymerization of the diiodo compound of formula I—(CF₂)₂ₙ—I with one or more haloolefin monomers. Thus, a diiodo compound is obtained of formula:

I—B—(CF₂)₂ₙ—B′—I, (IIb′)

in which n is 1, or 2, or 3, or 4, or 5, or 6 and B and B′ each represent a copolymer chain composed of halogenated units (preferably, B and B′ comprising the same halogenated units).

Thus, on conclusion of the controlled radical copolymerization step, the copolymer is obtained having the formula

I-A-B—(CF₂)₂ₙ—B′-A′-I, (IIb″)

in which n is equal to 1, or 2, or 3, or 4, or 5, or 6, and A, A′, B and B′ have the above meaning.

Next, following the functionalization step, the copolymer is obtained of formula:

X-A-B—(CF₂)₂ₙ—B′-A′-X, (IIb)

in which n is equal to 1, or 2, or 3, or 4, or 5, or 6, and A, A′, B and B′ have the above meaning.

According to one embodiment, B and B′ each represent a copolymeric polymer chain composed of a single unit, or of two different units, or of three different units, or of more than three different units, said units being derived from monomers of formula CY₁Y₂═CY₃Y₄, in which Y₁, Y₂, Y₃, Y₄ are chosen from H, F, Cl, Br, CF₃, C₂F and C₃F₇, at least one of them being a fluorine atom.

Said units of the chains B and B′ may be chosen especially from units derived from vinylidene fluoride, trifluoroethylene, tetrafluoroethylene, 2,3,3,3-tetrafluoropropene, vinyl fluoride, 2-chloro-1,1-difluoroethylene, chlorofluoro-1,1-ethylene, chlorofluoro-1,2-ethylene, chlorotrifluoroethylene, 2-bromo-1,1-difluoroethylene, hexafluoropropene, 3,3,3-trifluoropropene, 3,3,3-trifluoro-2-chloropropene, 1,3,3,3-tetrafluoropropene, 3,3,3-trifluoro-2-bromopropene, 1H-pentafluoropropene, 3,3,3-trifluoro-1-chloropropene, bromotrifluoroethylene and 2H-pentafluoropropene monomers.

The polymer chains B and B′ are preferably statistical polymer chains. They each preferably have a number-average molar mass of from 500 to 300 000 g/mol, preferably from 1000 to 100 000 g/mol and more preferentially from 2000 to 50 000 g/mol.

### Use of a Triiodo Chain-Transfer Agent

A triiodo chain-transfer agent is of general formula:

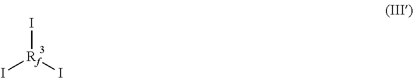

in which R_{f}³ represents a halogenated bonding group. Preferably, R_{f}³ is an aliphatic or aromatic fluoro group. On conclusion of the controlled radical copolymerization step, a copolymer is then obtained having the general formula:

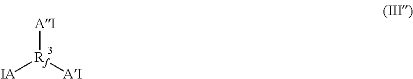

in which R_{f}³ has the same meaning as above and A, A′ and A″ each represent a polymer chain comprising VDF and tetrafluoropropene units, as defined above.

This copolymer is then subjected to the functionalization step, which gives the star copolymer of general formula:

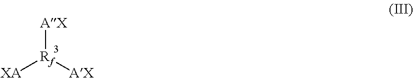

in which R_{f}³, A, A′ and A″ have the same meaning as above, and X represents a functional end group, as described in greater detail hereinbelow.

According to particular embodiments, the group R³ comprises an aromatic nucleus of benzene or triazine type, or an isocyanurate ring, or a phosphorus atom.

According to a particular embodiment, the triiodo compound is of formula:

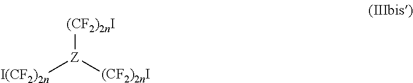

in which n is an integer equal to 1 or 2 or 3 or 4 or 5 or 6 and Z is a bonding group, preferably comprising a substituted or unsubstituted, saturated or aromatic ring, or comprising a phosphorus atom.

Thus, it is possible to provide a triiodo compound of formula:

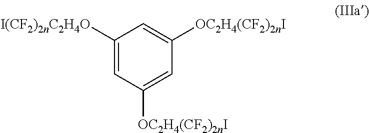

in which n is an integer equal to 1 or 2 or 3 or 4 or 5 or 6. This compound may be prepared in the following manner:
provision of the diiodo compound of formula I—CH₂—CH₂—(CF₂)₂ₙ—I, the preparation of which has already been described above;
reaction of this compound with phloroglucinol (or benzene-1,3,5-triol).

This reaction is a nucleophilic substitution of a triphenol with the compound I—CH₂—CH₂—(CF₂)ₙ—I, which may be performed, for example, as follows. A triphenoxide may first be obtained by addition of NaH or K₂CO₃ (in this case, the mixture is stirred under nitrogen, for example for 2 hours) or sodium hydroxide to phloroglucinol; this triphenoxide may then be added, for example dropwise at room temperature, to I—CH₂—CH₂—(CF₂)ₙ—I dissolved in dry methanol. After total addition, the mixture is heated at 40° C. and then at the reflux point of methanol for 5 hours. Monitoring is performed by gas chromatography until the phloroglucinol has disappeared. After reaction, the crude product is purified by column chromatography.

It is also possible to provide a triiodo compound of formula:

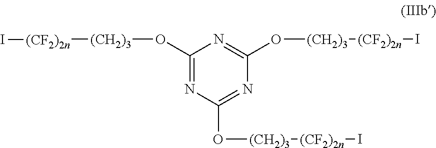

in which n is an integer equal to 1 or 2 or 3 or 4 or 5 or 6. This compound may be prepared in the following manner:
provision of the diiodo compound of formula I—(CF₂)₂ₙ—I;
reaction of this compound with 2,4,6-tris(allyloxy)-1,3,5-triazine (or triallyl cyanurate, TAC).

This reaction may be performed, for example, as follows. The reaction may be a radical reaction initiated either photochemically at room temperature, or in the presence of radical initiators (such as azobisisobutyronitrile or AIBN preferably at about 80° C., tert-butyl peroxypivalate preferably at about 74° C., tert-amyl peroxypivalate preferably at about 65° C., or bis(tert-butylcyclohexyl) peroxydicarbonate preferably at about 60° C., other peroxides, at temperatures at which their half-life time is preferably about one hour), or transition metal salts, or sodium dithionite/NaHCO₃/water/acetonitrile between 0 and 60° C. (as described by Zhang et al. in Chem. Soc. Rev., 41:4536-4559, 2012) or alternatively Et₃B at room temperature. The mixture may be stirred under nitrogen for 2 hours. The TAC may be dissolved in dry acetonitrile degassed beforehand, and the diiodo perfluoroalkane derivative I(CF₂)ₙ, dissolved in dry degassed acetonitrile, may be added dropwise at the required temperature. The reaction mixture may be left to stir at the same temperature for at least 6 hours and monitoring may be performed by gas chromatography until the diiodo compound has disappeared. After reaction, the crude product may be purified by column chromatography to give the desired derivative.

It is also possible to provide a triiodo compound of formula:

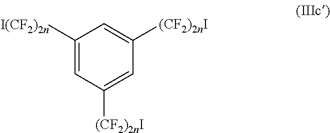

in which n is an integer equal to 1 or 2 or 3 or 4 or 5 or 6. This compound may be prepared in the following manner:
provision of the diiodo compound of formula I—(CF₂)₂ₙ—I;
reaction of this compound with 1,3,5-triiodobenzene.

This reaction may be performed, for example, in the presence of Cu⁰, Fe⁰, CuBr, CuCl₂; of ligands such as 4′-nonafluorobutylacetophenone, 2,2′-bipyridine, N,N,N″,N″,N′″,N′″-hexamethyltriethylenetetramine (HMTETA), N,N,N′,N″,N″-pentamethyldiethylenetriamine (PMDETA); and dimethyl sulfoxide (DMSO) or N,N-dimethylformamide (DMF) as solvent. By way of example, if Cu⁰, 2,2′-bipyridine and DMF are used, a good initial diiodo compound/triiodobenzene/ligand/metal/solvent mole ratio is about 1/1/0.3/10/4. The temperature may be from about 50 to 140° C., more precisely from about 80 to 130° C., and the reaction time from about 12 to 24 hours.

It is also possible to provide a triiodo compound (in the sense defined above) of formula:

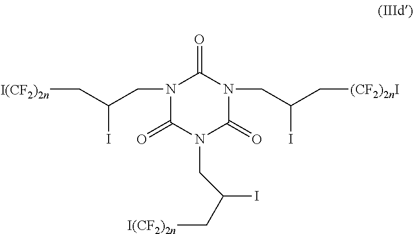

in which n is an integer equal to 1 or 2 or 3 or 4 or 5 or 6. This compound may be prepared in the following manner:
provision of the diiodo compound of formula I—(CF₂)₂ₙ—I;
reaction of this compound with triallyl isocyanurate (TAIC).

This reaction may be performed, for example, as follows. The reaction may be a radical reaction initiated either photochemically at room temperature, or in the presence of radical initiators (such as AIBN preferably at about 80° C., tert-butyl peroxypivalate preferably at about 74° C., tert-amyl peroxypivalate preferably at about 65° C., or bis(tert-butylcyclohexyl) peroxydicarbonate preferably at about 60° C., other peroxides, at temperatures at which their half-life time is preferably one hour), or transition metal salts, or sodium dithionite/NaHCO₃/water/acetonitrile between 0 and 60° C. (as described by Zhang et al. in Chem. Soc. Rev., 41:4536-4559, 2012) or Et₃B at room temperature. The TAIC may be dissolved in acetonitrile and the diiodo derivative I(CF₂)ₙI, dissolved in acetonitrile, is added dropwise at the required temperature. The reaction mixture may be left to stir at the same temperature for at least 6 hours and monitoring may be performed by gas chromatography until the diiodo compound has disappeared. After reaction, the crude product may be purified by column chromatography.

It is also possible to provide a triiodo compound of formula:

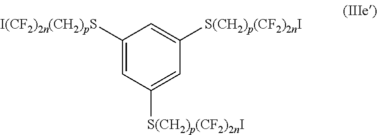

in which n is an integer equal to 1 or 2 or 3 or 4 or 5 or 6 and p is an integer equal to 1 or 2 or 3. This compound may be prepared in the following manner:
provision of the monoiodo compound of formula CH₂═CH—(CF₂)₂ₙ—I or of the monoiodo compound of formula CH₂═CH—CH₂—(CF₂)₂ₙ—I, which have already been described above;
reaction of one or other of these compounds with 1,3,5-benzenetrithiol, with a radical initiator, BF₃, or UV initiation.

This reaction may be performed, for example, as follows. The reaction may be a radical reaction initiated either photochemically at room temperature, or in the presence of radical initiators (such as AIBN preferably at about 80° C., tert-butyl peroxypivalate preferably at about 74° C., tert-amyl peroxypivalate preferably at about 65° C. or bis(tert-butylcyclohexyl) peroxydicarbonate preferably at about 60° C., other peroxides, at temperatures at which their half-life time is preferably about one hour). The process may be performed by bringing a two-necked round-bottomed flask equipped with a condenser, containing 1,3,5-benzenetrithiol and an excess of diiodo derivative (about threefold excess) dissolved in acetonitrile, to the required temperature. The reaction mixture may then be stirred at the same temperature for at least 6 hours and monitoring may be performed by ¹H NMR spectroscopy until the signal at about 2.2 ppm attributed to the SH group of 1,3,5-benzenetrithiol has totally disappeared. After reaction, the excess iodo derivative may be removed by flash chromatography.

It is also possible to provide a triiodo compound (in the sense defined above) of formula:

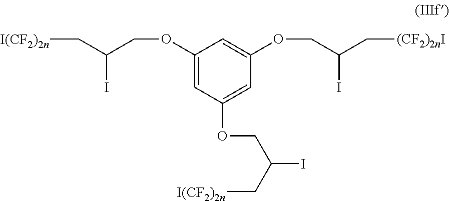

in which n is an integer equal to 1 or 2 or 3 or 4 or 5 or 6. This compound may be prepared in the following manner:
reaction of 1,3,5-trifluorobenzene with 3-propenol, to give 1,3,5-triallyloxybenzene;
reaction of this compound with the diiodo compound of formula I—(CF₂)₂ₙ—I, by radical initiation.

The first reaction may be performed, for example, as follows. 3-Propenol may be dissolved in dry acetonitrile, to which may be added NaH, and the mixture may be stirred under nitrogen for about 2 hours. Next, 1,3,5-trifluorobenzene (in a proportion three times smaller than the 3-propenol, dissolved in dry acetonitrile) may be added dropwise, at room temperature. The reaction mixture may be heated at 40 and then 60° C. with stirring for at least 6 hours and monitoring may be performed by IR spectroscopy until the OH vibration frequency at about 3200-3500 cm⁻¹ has disappeared.

The second reaction consists of the radical addition of 1,6-diiodoperfluorohexane to 1,3,5-triallyloxybenzene described previously; it may be, for example, a radical reaction initiated either photochemically at room temperature, or in the presence of radical initiators (such as AIBN preferably at about 80° C., tert-butyl peroxide preferably at about 74° C., tert-amyl peroxypivalate preferably at about 65° C. or bis(tert-butylcyclohexyl) peroxydicarbonate preferably at about 60° C., other peroxides preferably at temperatures at which their half-life time is about one hour).

It is also possible to provide a triiodo compound of formula:

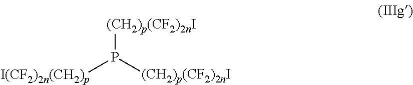

in which n is an integer equal to 1 or 2 or 3 or 4 or 5 or 6 and p is an integer equal to 1 or 2. This compound may be prepared in the following manner:
provision of the monoiodo compound of formula CH₂═CH—(CF₂)₂ₙ—I or of the monoiodo compound of formula CH₂═CH—CH₂—(CF₂)₂ₙ—I, which have already been described above;
reaction of one of these compounds with phosphine.

The reaction may be performed, for example, using at least four times as much fluoroiodo vinyl or allyl derivative, in the presence of AIBN preferably at about 80° C. or of tert-butyl peroxypivalate preferably at about 74° C., or of tert-amyl peroxypivalate preferably at about 65° C. or of bis(tert-butylcyclohexyl) peroxydicarbonate preferably at about 60° C., or of other peroxides, preferably at temperatures at which their half-life time is about one hour.

It is also possible to provide a triiodo compound of formula:

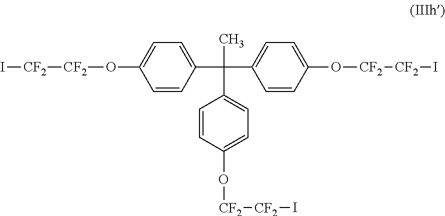

This compound may be prepared from the corresponding triboro compound (in which the iodine atoms are replaced with boron atoms), which is a commercial product sold by the American company Tetramers LLC.

Thus, on conclusion of the controlled radical copolymerization step, the copolymers corresponding to the following formulae may be obtained:

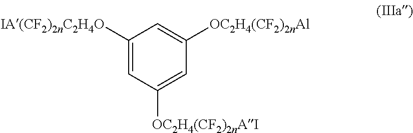

in which n is equal to 1, or 2, or 3, or 4, or 5, or 6, and A, A′ and A″ have the above meaning;

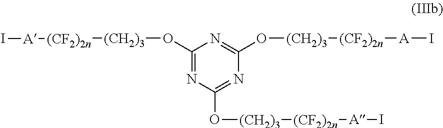

in which n is equal to 1, or 2, or 3, or 4, or 5, or 6, and A, A′ and A″ have the above meaning;

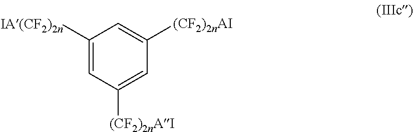

in which n is equal to 1, or 2, or 3, or 4, or 5, or 6, and A, A′ and A″ have the above meaning;

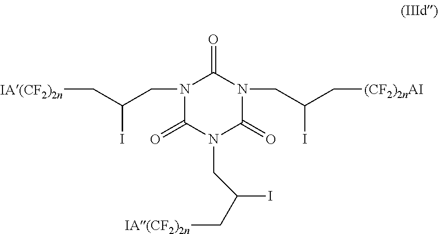

in which n is equal to 1, or 2, or 3, or 4, or 5, or 6, and A, A′ and A″ have the above meaning;

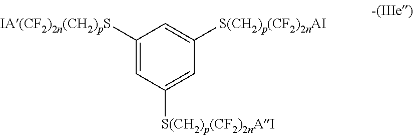

in which n is equal to 1, or 2, or 3, or 4, or 5, or 6, p is equal to 1 or 2, and A, A′ and A″ have the above meaning;

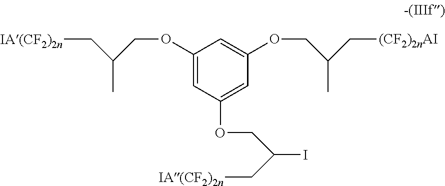

in which n is equal to 1, or 2, or 3, or 4, or 5, or 6, and A, A′ and A″ have the above meaning;

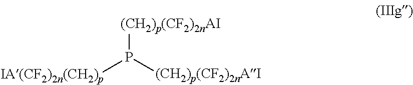

in which n is equal to 1, or 2, or 3, or 4, or 5, or 6, p is equal to 1 or 2, and A, A′ and A″ have the above meaning;

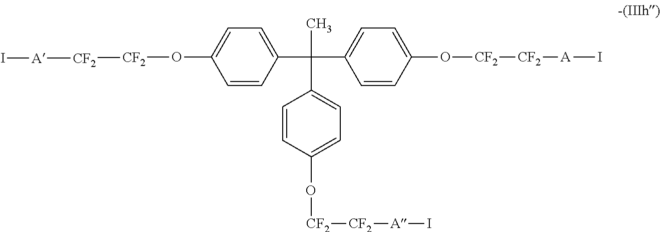

in which A, A′ and A″ have the above meaning.

Following the functionalization step, the copolymers corresponding to the following formulae are obtained:

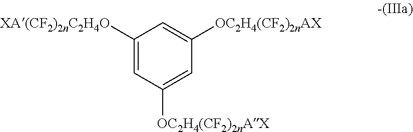

in which n is equal to 1, or 2, or 3, or 4, or 5, or 6, and A, A′ and A″ have the above meaning;

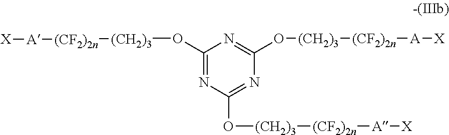

in which n is equal to 1, or 2, or 3, or 4, or 5, or 6, and A, A′ and A″ have the above meaning;

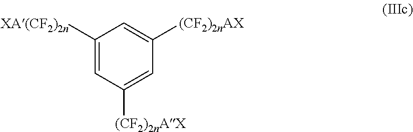

in which n is equal to 1, or 2, or 3, or 4, or 5, or 6, and A, A′ and A″ have the above meaning;

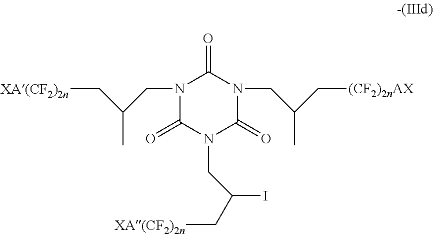

in which n is equal to 1, or 2, or 3, or 4, or 5, or 6, and A, A′ and A″ have the above meaning;

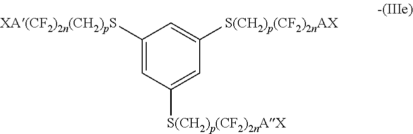

in which n is equal to 1, or 2, or 3, or 4, or 5, or 6, p is equal to 1 or 2, and A, A′ and A″ have the above meaning;

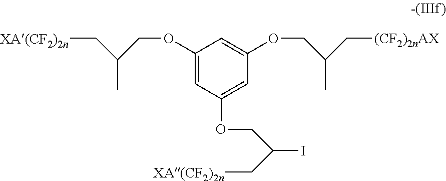

in which n is equal to 1, or 2, or 3, or 4, or 5, or 6, and A, A′ and A″ have the above meaning;

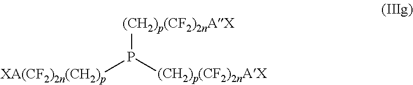

in which n is equal to 1, or 2, or 3, or 4, or 5, or 6, p is equal to 1 or 2, and A, A′ and A″ have the above meaning;

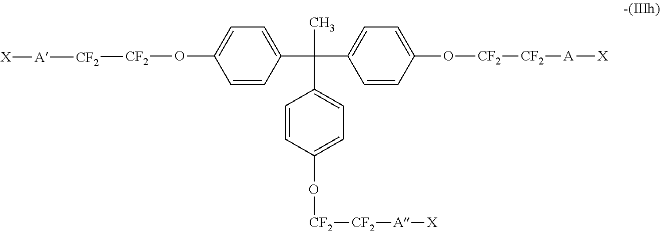

in which A, A′ and A″ have the above meaning.

### Use of a Tetraiodo Chain-Transfer Agent

A tetraiodo chain-transfer agent is of general formula:

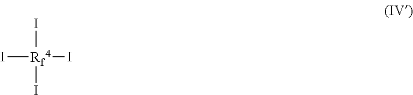

in which R_{f}⁴ represents a halogenated bonding group. Preferably, R_{f}⁴ is a fluoro group. On conclusion of the controlled radical copolymerization step of fluoro monomers, a star copolymer is then obtained having the general formula:

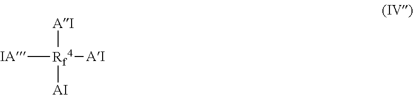

in which R_{f}⁴ has the same meaning as above and A, A′, A″ and A′″ each represent a polymer chain comprising VDF and 1234 units, as defined above.

This copolymer is then subjected to the functionalization step, which gives the star copolymer of general formula:

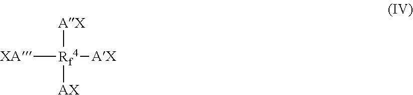

in which R_{f}⁴, A, A′, A″ and A′″ have the same meaning as above, and X represents a functional end group, as described in greater detail hereinbelow.

According to a particular embodiment, the tetraiodo compound is of formula:

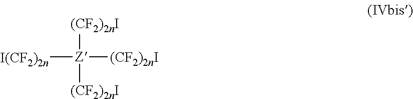

in which n is an integer equal to 1 or 2 or 3 or 4 or 5 or 6 and Z′ is a bonding group.

Thus, it is possible to provide a tetraiodo compound of formula (IVa′):

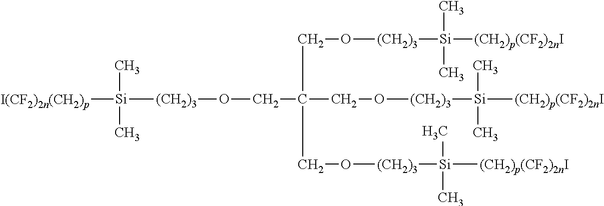

in which n is an integer equal to 1 or 2 or 3 or 4 or 5 or 6 and p is an integer equal to 2 or 3. This compound may be prepared in the following manner:
preparation of the monoiodo compound Cl—[Si(CH₃)₂]—(CH₂)ₚ—(CF₂)₂ₙ—I, by reacting dimethylchlorosilane with a monoiodo compound of formula CH₂═CH—(CF₂)₂ₙ—I or of formula CH₂═CH—CH₂—(CF₂)₂ₙ—I, both already described above;
reduction of the compound obtained in the preceding step in the presence of lithium aluminum hydride (LiAlH₄) to obtain the monoiodo compound H—[Si(CH₃)₂]—(CH₂)ₚ—(CF₂)₂ₙ—I;
preparation of the compound of formula C(CH₂—O—CH₂—CH═CH₂)₄ by reacting pentaerythritol of formula C(CH₂—OH)₄ with the compound of formula X—CH₂—CH═CH₂ (with X═Cl or Br);

reaction of the compound of formula H—Si(CH₃)₂—(CH₂)ₚ—(CF₂)₂ₙ—I with the compound of formula C(CH₂—O—CH₂—CH═CH₂)₄ in the presence of a platinum catalyst such as H₂PtCl₆ (Spiers catalyst) or a Karsted catalyst.

The first step and the second step may be performed, for example, as described in the publication from Ameduri et al., in J. Fluorine Chem., 74:191-197 (1995). In particular, the first step may be performed in the presence of H₂PtCl₆ at 80-120° C. or of tert-butyl peroxide at 130-145° C. for at least 6 hours.

The third step may be performed in basic medium, in the presence of a phase-transfer catalyst, such as sodium tetrabutyl hydrogen sulfate (TBAH).

The fourth step may be performed, for example, as follows. A large excess of H—Si(CH₃)₂—(CH₂)ₚ—(CF₂)₂ₙ—I (at least a fivefold molar excess) is placed in contact with C(CH₂—O—CH₂—CH═CH₂)₄ for 6-10 hours, in the presence of H₂PtCl₆ at 0.5-2.0 mol % with respect to the tetrallyl, at 80-120° C.; or for at least 6 hours, in the presence of tert-butyl peroxide at 10-20 mol % relative to the tetrallyl, at 130-145° C.

It is also possible to provide a tetraiodo compound of formula (IVb′):

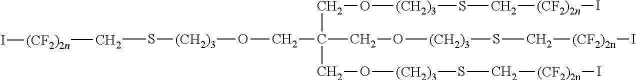

in which n is an integer equal to 1 or 2 or 3 or 4 or 5 or 6. This compound may be prepared in the following manner:
preparation of the compound of formula C(CH₂—O—CH₂—CH═CH₂)₄ as described above;
reaction of this compound with the monoiodo compound of formula HS—C₂H₄—(CF₂)₂ₙ—I.

This reaction may be performed, for example, as follows. The reaction may be a radical reaction initiated either photochemically at room temperature, or in the presence of radical initiators (such as azobisisobutyronitrile or AIBN preferably at about 80° C., tert-butyl peroxypivalate preferably at about 74° C., tert-amyl peroxypivalate preferably at about 65° C. or bis(tert-butylcyclohexyl) peroxydicarbonate preferably at about 60° C., other peroxides, at temperatures at which their half-life time is preferably about one hour). Use may be made, for example, of a two-necked round-bottomed flask under a stream of nitrogen or argon, equipped with a condenser, containing HS—C₂H₄—(CF₂)₂ₙ—I in large excess and the derivative C(CH₂—O—CH₂—CH═CH₂)₄ (about 4-6 times more HS—C₂H₄—(CF₂)₂ₙ—I (prepared by Barthélémy et al., in Org. Lett. 1:1689-1692 (2000)) with respect to C(CH₂—O—CH₂—CH═CH₂)₄), dissolved in acetonitrile. The initiator may then be added. The initial [radical initiator]ₒ/[C(CH₂—O—CH₂—CH═CH₂)₄]ₒ mole ratio may be, for example, from 5 to 10%. The mixture may be brought to the required temperature and stirred at the same temperature for at least 6 hours. The reaction monitoring may be performed by ¹H NMR spectroscopy until the signals at about 5-6 ppm attributed to the vinyl groups of the C(CH₂—O—CH₂—CH═CH₂)₄ have totally disappeared. After reaction, the excess derivative HS—C₂H₄—(CF₂)₂ₙ—I may be removed by flash chromatography. Reference may also be made to the article from Barthélémy et al., in Org. Lett. 1:1689-1692 (2000).

It is also possible to provide a tetraiodo compound of formula (IVc′):

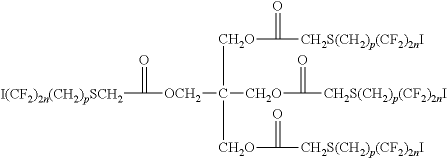

in which n is an integer equal to 1 or 2 or 3 or 4 or 5 or 6 and p is an integer equal to 1 or 2. This compound may be prepared in the following manner:
preparation of the compound of formula C(CH₂—O—(C═O)—CH₂—SH)₄ by reacting the compound of formula C(CH₂—OH)₄ with the compound of formula HS—CH₂—COOH;
reaction of this compound with the monoiodo compound of formula CH₂═CH—(CF₂)₂ₙ—I or of formula CH₂═CH—CH₂—(CF₂)₂ₙ—I, which have both already been described above.

The first preparation is based on an esterification which may be catalyzed with methanesulfonic acid, for example with a toluene/water Dean-Stark system and an initial thiol/pentaerythritol mole ratio of 4-6.

The second reaction may be performed, for example, as follows. The reaction may be a radical reaction initiated either photochemically at room temperature or even in the presence of sunlight, or in the presence of radical initiators (such as azobisisobutyronitrile or AIBN preferably at about 80° C., tert-butyl peroxypivalate preferably at about 74° C., tert-amyl peroxypivalate preferably at about 65° C. or bis(tert-butylcyclohexyl) peroxydicarbonate preferably at about 60° C., other peroxides, at temperatures at which their half-life time is preferably about one hour). Use may be made, for example, of a two-necked round-bottomed flask under a stream of nitrogen or argon, equipped with a condenser, containing CH₂═CH—(CH₂)_{f}(CF₂)₂ₙ—I (f=0 or 1) in excess and the derivative C(CH₂—O—(C═O)—CH₂—SH)₄ (about 4-6 times more of CH₂—CH—(CH₂)_{f}(CF₂)₂ₙ—I than of tetrathiol), dissolved in acetonitrile. The initiator is then added. The initial [radical initiator]ₒ/[CH₂═CH—(CH₂)_{f}(CF₂)₂ₙ—I]ₒ mole ratio may be from 5 to 10%. The mixture may be brought to the required temperature and stirred at this same temperature for at least 6 hours and monitoring may be performed by ¹H NMR spectroscopy until the signals at about 1.5 ppm attributed to the characteristic SH group of the tetrathiol have totally disappeared. After reaction, the excess vinyl or allyl derivative may be removed by flash chromatography.

It is also possible to provide a tetraiodo compound of formula (IVd′):

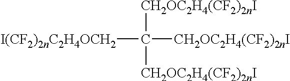

in which n is an integer equal to 1 or 2 or 3 or 4 or 5 or 6. This compound may be prepared in the following manner:
reaction of the compound of formula C(CH₂—OH)₄ with the diiodo compound of formula I—CH₂—CH₂—(CF₂)₂ₙ—I, already described above.

The compound I—CH₂—CH₂—(CF₂)₂ₙ—I may be prepared, for example, by ethylenation of I—(CF₂)₂—I, as described in the article from Barthélémy et al., in Org. Lett. 1:1689-1692 (2000). Pentaerythritol C(CH₂—OH)₄ may be dissolved in dry methanol, to which may be added either NaH, or K₂CO₃, or 40% sodium hydroxide. The mixture may be stirred at room temperature for 2 hours, followed by dropwise addition of a solution containing I—CH₂—CH₂—(CF₂)₂ₙ—I dissolved in dry acetonitrile. The initial [I—CH₂—CH₂—(CF₂)₂ₙ—I]ₒ/[C(CH₂—OH)₄]ₒ mole ratio may be, for example, 4-5.

It is also possible to provide a tetraiodo compound of formula (IVe′):

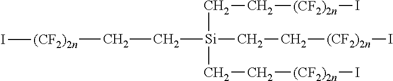

in which n is an integer equal to 1 or 2 or 3 or 4 or 5 or 6. This compound may be prepared by reacting the compound H₂C═CH—R—(CF₂)ₙ—I with the compound [I(CF₂)ₙCH₂CH₂]₃Si—H.

Thus, on conclusion of the controlled radical copolymerization step, the copolymers corresponding to the following formulae may be obtained:

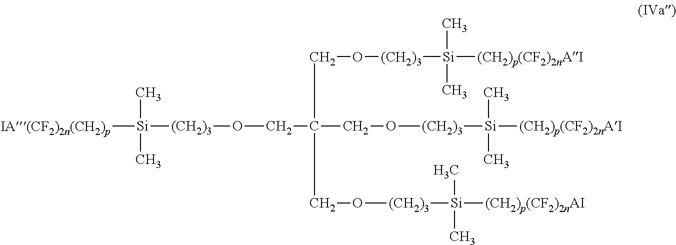

in which n is an integer equal to 1, or 2, or 3, or 4, or 5, or 6, p is equal to 1 or 2, and A, A′, A″ and A′″ have the above meaning;

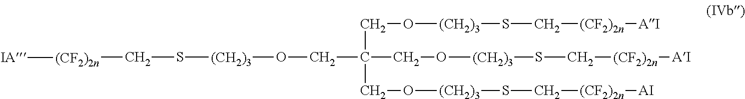

in which n is equal to 1, or 2, or 3, or 4, or 5, or 6, and A, A′, A″ and A′″ have the above meaning;

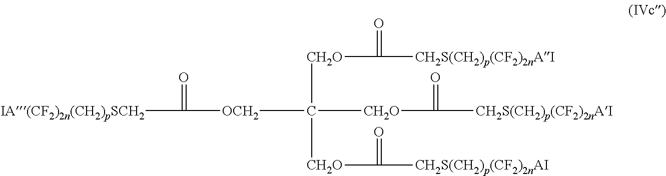

in which n is equal to 1, or 2, or 3, or 4, or 5, or 6, p is equal to 1 or 2, and A, A′, A″ and A′″ have the above meaning;

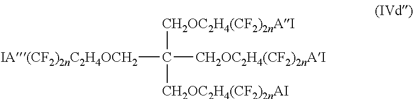

in which n is equal to 1, or 2, or 3, or 4, or 5, or 6, and A, A′, A″ and A′″ have the above meaning;

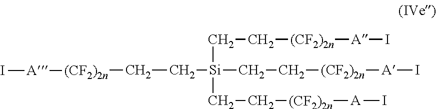

in which n is equal to 1, or 2, or 3, or 4, or 5, or 6, and A, A′, A″ and A′″ have the above meaning.

Following the functionalization step, the copolymers corresponding to the following formulae are obtained:

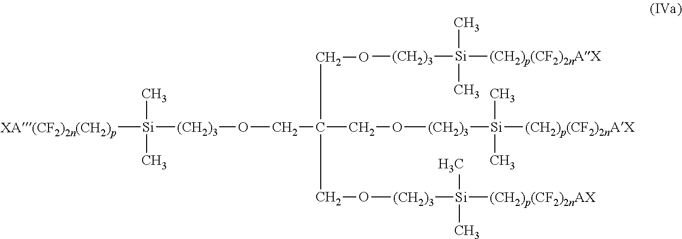

in which n is equal to 1, or 2, or 3, or 4, or 5, or 6, p is equal to 1 or 2, and A, A′, A″ and A′″ have the above meaning, X being defined in greater detail hereinbelow;

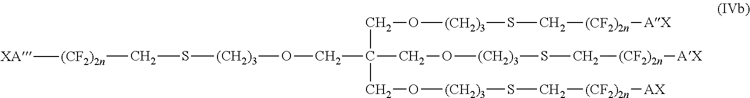

in which n is equal to 1, or 2, or 3, or 4, or 5, or 6, and A, A′, A″ and A′″ have the above meaning, X being defined in greater detail hereinbelow;

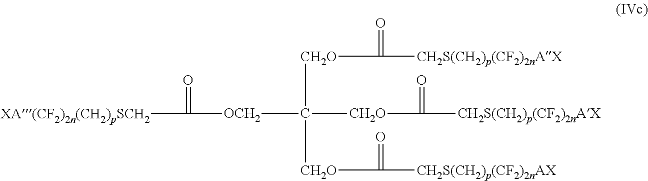

in which n is equal to 1, or 2, or 3, or 4, or 5, or 6, p is equal to 1 or 2, and A, A′, A″ and A′″ have the above meaning, X being defined in greater detail hereinbelow;

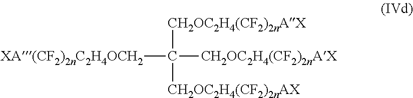

in which n is equal to 1, or 2, or 3, or 4, or 5, or 6, and A, A′, A″ and A′″ have the above meaning, X being defined in greater detail hereinbelow.

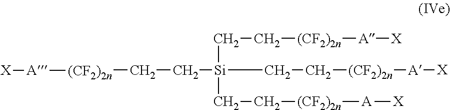

### Controlled Radical Polymerization Reaction

The controlled radical polymerization reaction is performed starting with at least two VDF and tetrafluoropropene monomers (and optionally additional monomers if they are present), in the presence of a chain-transfer agent as described above, and an initiator. The initiator may be, for example, tert-butyl peroxypivalate, tert-amyl peroxypivalate, bis(4-tert-butylcyclohexyl) peroxydicarbonate, sodium, ammonium or potassium persulfate, benzoyl peroxide, tert-butyl hydroperoxide, tert-butyl peroxide, cumyl peroxide or 2,5-bis(tert-butylperoxy)-2,5-dimethylhexane.

The reaction is performed in a solvent which is chosen, for example, from 1,1,1,3,3-pentafluorobutane, acetonitrile, methyl ethyl ketone, 2,2,2-trifluoroethanol, hexafluoroisopropanol, dimethyl carbonate, methyl acetate, ethyl acetate, cyclohexanone and water, and mixtures thereof.

The reaction is preferably performed at a maximum temperature (after temperature rise) of from 10 to 200° C., preferably from 40 to 170° C., at a pressure of from 10 to 120 bar, preferably from 20 to 80 bar. The choice of the optimum temperature depends on the initiator that is used. Generally, the reaction is performed for at least 6 hours, at a temperature at which the half-life time of the initiator is from 1 to 3 hours approximately.

The mole ratio of the amount of initiator to the amount of monomers ranges from 0.0005 to 0.02 and preferably from 0.001 to 0.01. The mole ratio of the amount of chain-transfer agent to the amount of monomers makes it possible to control the molar mass of the copolymer. Preferably, this ratio is from 0.001 to 0.1 and more preferentially from 0.005 to 0.02.

The initial mole ratio of the amount of VDF monomer to the amount of 1234 monomer(s) may be, for example, from 0.01 to 0.99 and preferably from 0.05 to 0.90.

The polymer chains obtained are of the statistical copolymer type.

The number-average molar mass of each polymer chain A, A′, A″, A′″ of the copolymer obtained is preferably from 700 to 400 000 g/mol, more preferentially from 2000 to 150 000 g/mol.

The polydispersity index of each polymer chain A, A′, A″, A′″ of the copolymer obtained is preferably from 1.1 to 1.8, more preferentially from 1.2 to 1.6.

### Terminal Functionalization Reaction

According to the invention, each iodo end group at the end of a polymer chain A, A′, A″, A′″ comprising VDF and tetrafluoropropene units may be transformed into a functional end group X via a functionalization step.

The functional end group X comprises an alcohol, acetate, vinyl, azide, amine, carboxylic acid, (meth)acrylate, epoxide, cyclocarbonate, alkoxysilane or vinyl ether function.

According to one embodiment, the iodo copolymer is reacted with allyl acetate.

This makes it possible to convert the iodo (—I) end group(s) of the copolymer into —CH₂—CHI—CH₂—OAc end groups (OAc representing the acetate function). The reaction may be initiated, for example, with benzoyl peroxide at 90° C. over 30 minutes to 2 hours. This reaction may be exothermic with a temperature rise up to 170° C. (the stoichiometry with respect to the number of iodine atoms should preferably be respected).

These —CH₂—CHI—CH₂—OAc end groups may then, where appropriate, be converted into —(CH₂)—CH═CH₂ end groups, by reaction in the presence of zinc. The reaction may be performed, for example, in the following manner: the copolymer may be dissolved beforehand in a solvent such as dry DMF or dimethylacetamide, and then added dropwise to a solution composed of activated zinc (activated with a few drops of bromine or by ultrasonication) and of this same solvent (the [zinc]J[iodoacetate copolymer]ₒ mole ratio being from 2.5 to 4). After addition, the mixture may be maintained at 80-110° C. for at least 3 hours and the reaction monitoring may be performed by ¹H NMR via the disappearance of the signals at about 4.5 ppm attributed to the CHI group and the presence of the signals between 5 and 6.5 ppm assigned to the allylic end.

According to one embodiment, the iodo copolymer may be reacted with 3-propenol. This makes it possible to convert the —I end group(s) of the copolymer into —CH₂—CHI—CH₂—OH end groups. For example, this reaction may be performed in the presence of AIBN with addition every 30 minutes at a temperature of 75-85° C.

It is then possible to convert these —CH₂—CHI—CH₂—OH end groups into —CH₂—CH₂—CH₂—OH alcohol end groups, for example in the presence of tributyltin hydride. For example, the iodohydrin may be dissolved in a dry polar solvent and then added dropwise to a mixture composed of AIBN and tributyltin hydride at 10° C. The reaction mixture may be maintained at room temperature for 1 hour and then at 40° C. and finally at 60° C. for at least 3 hours and reaction monitoring may be performed by ¹H NMR via disappearance of the signals at about 4.5 ppm attributed to the CHI group and the presence of the signal at about 1.8 ppm attributed to the central CH₂ of the CH₂CH₂CH₂OH end.

It is then possible to convert these alcohol end groups —CH₂—CH₂—CH₂—OH into acrylate end groups —CH₂—CH₂—CH₂—O—C(═O)—CH═CH₂, or alternatively into methacrylate end groups —CH₂—CH₂—CH₂—O—C(═O)—C(CH₃)═CH₂, by reacting acryloyl chloride or, respectively, methacryloyl chloride.

Instead of the reaction with 3-propenol, it is more generally possible to perform a similar reaction with an alkenol of formula CH₂═CH—(CH₂)ₘ—OH, m being an integer from 1 to 10. This makes it possible to obtain alcohol end groups —CH₂—CH₂—(CH₂)ₘ—OH, acrylate end groups —CH₂—CH₂—(CH₂)ₘ—O—C(═O)—CH═CH₂ and methacrylate end groups —CH₂—CH₂—(CH₂)ₘ—O—C(═O)—C(CH₃)═CH₂.

According to another embodiment, the iodo copolymer may be reacted with ethylene. This makes it possible to convert the —I end group(s) of the copolymer into —CH₂—CH₂—I end groups. The reaction may be performed, for example, as follows. In a reactor under pressure equipped with inlet and outlet valves, a manometer, a stirring anchor and a rupture disk, the reagents (copolymer, tert-butanol, bis(tert-butylcyclohexyl) peroxydicarbonate) may be introduced, and, after three vacuum/nitrogen cycles, the reactor is then cooled to −80° C., followed by transferring ethylene therein (in an equimolar proportion with the iodo functions of the copolymer). The reaction lasts 10-20 hours at 60° C. with an increase in pressure gradually as the reactor is heated, followed by a drop associated with the consumption of the ethylene; the conversion of the copolymer is quantitative, absence of the signal at −39 ppm observed in the ¹⁹F NMR spectrum showing the reactive ICF₂CH₂— end groups on the ethylene. Optionally, tert-butyl peroxypivalate may also be used as initiator at about 74° C. or tert-amyl peroxypivalate at about 65° C.

It is then possible to convert these —CH₂—CH₂—I end groups:
into alcohol end groups —CH₂—CH₂—OH by hydrolysis;
into acrylate end groups —CH₂—CH₂—O—CO—CH═CH₂ by reaction of the above alcohol end groups with acryloyl chloride;
into methacrylate end groups —CH₂—CH₂—O—CO—C(CH₃)═CH₂ by reaction of the above alcohol end groups with methacryloyl chloride;
into azide end groups —CH₂—CH₂—N₃ by reaction with sodium azide (moreover, the azide end groups —CH₂—CH₂—N₃ may in turn be converted into amine end groups —CH₂—CH₂—NH₂ by reaction with hydrazine);
into —CH₂—COOH end groups.

The reaction for conversion into alcohol end groups may be performed, for example, as follows. The bis(ethylene) poly(VDF-co-1234) copolymer may be dissolved in DMF. Water may be added thereto followed by sparging with nitrogen for 30 minutes. The reaction mixture may be heated at 100-110° C. with stirring for at least 12 hours. The crude reaction mixture may then be cooled to room temperature and a mixture of H₂SO₄ (25 g) in methanol (70 g) may be added dropwise. This mixture may be stirred at room temperature for 24 hours. The crude reaction mixture may then be washed with distilled water (3×100 mL), with Na₂S₂O₅ solution and with ethyl acetate (200 mL). The organic phase may be dried over MgSO₄ and filtered on a sinter funnel. The ethyl acetate and the traces of DMF may be removed on a rotary evaporator (40° C./20 mmHg). The viscous oil or the solid, depending on the proportions of VDF in the poly(VDF-co-1234) copolymer, may be dried at 40° C. under 0.01 mbar to constant weight. The copolymer may thus be obtained in a yield of about 65-80% and characterized by ¹H and ¹⁹F NMR.

The reaction for conversion into acrylate end groups may be performed, for example, as follows. The copolymer may be dissolved in dry THF and stirred with poly(4-vinylpyridine). The reaction mixture may be cooled to 0° C. and saturated with nitrogen (by sparging and maintaining under a stream of nitrogen), and 20 mg of hydroquinone may be added thereto. An excess of acryloyl chloride (about threefold relative to the OH end groups) may be added by syringe through a septum in four doses over an interval of 4 hours. After the first dose of acryloyl chloride has been added, the reaction mixture may be brought to 40° C. After reaction, the poly(4-vinylpyridine) may be removed by filtration. A 2-butanone/water mixture (1/1) may then be added thereto, followed by washing with water. The organic phase may be dried over MgSO₄. The solvents and the excess acryloyl chloride may be removed on a rotary evaporator (40° C./20 mmHg) and, after drying to constant weight, an oil or a wax or a powder may be recovered (as a function of the respective contents of the comonomers) and then characterized by ¹H and ¹⁹F NMR spectroscopy. The yield may range from 70 to 90%.

The reaction for conversion into methacrylate end groups may be performed like the preceding reaction, using either methacryloyl chloride or methacrylic anhydride as reagent. The yield may range from 65 to 85%.

The reaction for conversion into azide end groups may be performed, for example, as follows. In a Schlenk tube, the copolymer may be dissolved in a mixture of DMSO and water (in a DMSO/water volume ratio of about 25) and then stirred with an excess of sodium azide (in a ratio of 3). The solution may be stirred at 50° C. for 48 hours. After cooling to room temperature, the crude reaction mixture may be poured into a large excess of water and then extracted with a diethyl ether/dimethyl carbonate mixture. This protocol may be repeated twice. The organic phase may be washed twice with water, 10% sodium sulfite (twice), water (three times), sodium hydroxide, and finally dried over MgSO₄, and filtered. The solvent may be evaporated off under reduced pressure to give a greenish product in a yield of copolymer bearing azide end groups ranging from 60 to 75%.

The reaction for conversion into carboxylic acid end groups may be performed, for example, as follows. The copolymer may be dissolved in a mixture of acetone (7 parts) and diethyl ether (3 parts). A Jones catalyst (composed of 25 ml of pure sulfuric acid in a mixture of 25 g of chromium oxide and 70 mL of water) may be added dropwise at room temperature until an orange-brown color becomes persistent. After stirring for one hour, the crude reaction mixture may be worked up by washing twice with water and the fluorinated organic phase may then be extracted with diethyl ether, dried over MgSO₄, filtered and then concentrated. If the proportion of VDF is greater than 85 mol %, the solid product may be purified by precipitation from cold pentane. After drying to constant weight, the copolymer bearing acid end groups may be characterized by ¹H NMR spectroscopy (showing the absence of a signal centered at about 3.8 ppm attributed to the CH₂OH methylene groups). The yield may be from about 60 to 75%.

According to another embodiment, the iodo copolymer may be reacted with allyl glycidyl ether via photochemical initiation or in the presence of radical initiators mentioned above. This makes it possible to convert the —I end group(s) of the copolymer into —O—CH₂-epoxide end groups, in which the “epoxide” denotes the group:

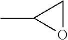

The reaction may be performed, for example, as follows. An excess of allyl glycidyl ether (as a function of the number of iodine atoms) may be stirred in the presence of benzoyl peroxide and of the iodo copolymer at 90° C. for 30 minutes to 3 hours. The resulting iodoepoxide copolymer bearing a —CF₂—CH₂CHICH₂OCH₂-epoxide end group is obtained in a yield of 80-85%. This reaction may be exothermic with a temperature rise up to 170° C. if the addition of initiator is performed at 90° C. The reduction of the iodine atoms may be performed in the presence of Bu₃SnH and AIBN as described previously for the production of the alcohol end groups.

According to another embodiment, carbonatation of the epoxide end groups may be performed, so as to convert the —O—CH₂-epoxide end groups into —O—CH₂-cyclocarbonate end groups, in which “cyclocarbonate” denotes the group:

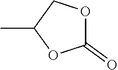

The reaction may be performed, for example, as follows. The epoxidized copolymer may be dissolved in DMF, to which may be added lithium bromide (LiBr/copolymer ratio=1/20), and placed in a reactor under pressure. After closing, the reactor may be pressurized with 15 bar of CO₂ and then heated at 80° C. with stirring for 16 hours. After reaction, the autoclave may be cooled and the excess gas evacuated. The DMF may be removed under reduced pressure. The desired copolymer may be precipitated from a large excess of cold pentane. If a powder precipitates out (i.e. especially if the content of VDF in the poly(VDF-co-tetrafluoropropene) copolymer is greater than 85%), the copolymer may be filtered off. For contents of 1234 units of greater than 20%, amorphous waxes that stick to the walls of the flask may generally be obtained. The excess pentane may be eliminated and the copolymer sticking to the walls may then be dissolved in acetone and reprecipitated from an excess of pentane, dried to constant weight and finally characterized by ¹H and ¹⁹F NMR.

According to another embodiment, the alcohol end groups described previously are converted into vinyl ether —O—CH═CH₂ end groups.

This conversion may be performed, for example, as follows. Palladium acetate and 1,10-phenanthroline (in slight excess) may be dissolved separately in dichloromethane and mixed in a Schlenk tube at 20° C. for 15 minutes. This solution, the poly(VDF-co-1234) copolymer bearing alcohol end groups described previously and a large excess of vinyloxyethane (or ethyl vinyl ether, 20 times more) may be placed in a pressurized reactor. This autoclave may be closed and the reaction mixture heated with stirring at 60° C. for 48 hours. The volatile reagents may be removed on a rotary evaporator. The crude product may be diluted in a large excess of diethyl ether/dimethyl carbonate and the catalyst precipitated out and filtered off. After evaporating off the diethyl ether, the resulting copolymer may be precipitated from a large excess of cold pentane, dried and then analyzed by ¹H NMR spectroscopy, which reveals the characteristic signals of the vinyl ether end groups at 4.16 (dd, CHH═CH—O, ²J_{gem}=1.64 Hz, ³Jₜᵣₐₙₛ=14.27 Hz, 2H) and 6.51 (ddt, CH₂═CHO, ³J_{cis}=6.82 Hz, 3Jₜᵣₐₙₛ=14.27 Hz, ⁴J=0.51 Hz, 1H).

According to another embodiment, the alcohol end groups described previously are converted into alkoxysilane end groups, for example into trialkoxysilane end groups (for example tri(m)ethoxysilanes) or dialkoxymethylsilane end groups (for example di(m)ethoxymethylsilane) or alkoxydimethylsilane end groups (for example (m)ethoxydimethylsilane).

This conversion may be performed, for example, as follows. An excess of vinyltrialkoxysilane (or of vinyldialkoxymethylsilane or of vinylalkoxydimethylsilane) such as vinyltriethoxysilane (or vinyldiethoxymethylsilane or vinylethoxydimethylsilane) may be stirred in the presence of benzoyl peroxide and of iodo copolymer at 90° C. or tert-butyl peroxypivalate preferably at about 74° C. for 1 to 5 hours. The excess may be adjusted as a function of the number of iodine atoms: for example, an excess of 3 for 2 iodine atoms, 4 for 2 iodine atoms and 5-6 for 4 iodine atoms). This reaction may be exothermic with a temperature rise up to 170° C. if the addition of initiator is performed at 90° C.

Preferred functional end groups are thus the following groups:
X1: —CH₂—CHI—CH₂—OH;
X2: —CH₂—CHI—CH₂—OAc;
X3: —CH₂—CH₂—OH;
X4: —CH₂—CH₂—CH₂—OH;
X5: —CH₂—CH₂—O—CO—CH═CH₂;
X6: —CH₂—CH₂—CH₂—O—CO—CH═CH₂;
X7: —CH₂—CH₂—O—CO—C(CH₃)═CH₂;
X8: —CH₂—CH₂—CH₂—O—CO—C(CH₃)═CH₂;
X9: —CH₂—CH₂—N₃;
X10: —CH₂—CH₂—NH₂;
X11: —CH₂—COOH;
X12: —(CH₂)—CH═CH₂;
X13: —O—CH═CH₂;
X14: —O—CH₂-epoxide,
X15: —O—CH₂-cyclocarbonate,
X16: CH₂—CHI—CH₂Si(OR)₃ or CH₂—CHI—CH₂Si(OR)₂CH₃ or CH₂—CHI—CH₂Si(OR)CH₃)₂, with R representing an alkyl group comprising from 1 to 10 carbon atoms.

Particular copolymers according to the invention are thus the following copolymers:
P-I-1: copolymer of formula (I) with R_{f}¹═F—(CF₂)₂ₙ and X═X1;
P-I-2: copolymer of formula (I) with R_{f}¹═F—(CF₂)₂ₙ and X═X2;
P-I-3: copolymer of formula (I) with R_{f}¹═F—(CF₂)₂ₙ and X═X3;
P-I-4: copolymer of formula (I) with R_{f}¹═F—(CF₂)₂ₙ and X═X4;
P-I-5: copolymer of formula (I) with R_{f}¹═F—(CF₂)₂ₙ and X═X5;
P-I-6: copolymer of formula (I) with R_{f}¹═F—(CF₂)₂ₙ and X═X6;
P-I-7: copolymer of formula (I) with R_{f}¹═F—(CF₂)₂ₙ and X═X7;
P-I-8: copolymer of formula (I) with R_{f}¹═F—(CF₂)₂ₙ and X═X8;
P-I-9: copolymer of formula (I) with R_{f}¹═F—(CF₂)₂ₙ and X═X9;
P-I-10: copolymer of formula (I) with R_{f}¹═F—(CF₂)₂ₙ and X═X10;
P-I-11: copolymer of formula (I) with R_{f}¹═F—(CF₂)₂ₙ and X═X11;
P-I-12: copolymer of formula (I) with R_{f}¹═F—(CF₂)₂ₙ and X═X12;
P-I-13: copolymer of formula (I) with R_{f}¹═F—(CF₂)₂ₙ and X═X13;
P-I-14: copolymer of formula (I) with R_{f}¹═F—(CF₂)₂ₙ and X═X14;
P-I-15: copolymer of formula (I) with R_{f}¹═F—(CF₂)₂ₙ and X═X15;
P-I-16: copolymer of formula (I) with R_{f}¹═F—(CF₂)₂ₙ and X═X16;
P-II-1: copolymer of formula (II) with R_{f}²═(CF₂)₂ₙ and X═X1;
P-II-2: copolymer of formula (II) with R_{f}²═(CF₂)₂ₙ and X═X2;
P-II-3: copolymer of formula (II) with R_{f}²═(CF₂)₂ₙ and X═X3;
P-II-4: copolymer of formula (II) with R_{f}²═(CF₂)₂ₙ and X═X4;
P-II-5: copolymer of formula (II) with R_{f}²═(CF₂)₂ₙ and X═X5;
P-II-6: copolymer of formula (II) with R_{f}²═(CF₂)₂ₙ and X═X6;
P-II-7: copolymer of formula (II) with R_{f}²═(CF₂)₂ₙ and X═X7;
P-II-8: copolymer of formula (II) with R_{f}²═(CF₂)₂ₙ and X═X8;
P-II-9: copolymer of formula (II) with R_{f}²═(CF₂)₂ₙ and X═X9;
P-II-10: copolymer of formula (II) with R_{f}²═(CF₂)₂ₙ and X═X10;
P-II-11: copolymer of formula (II) with R_{f}²═(CF₂)₂ₙ and X═X11;
P-II-12: copolymer of formula (II) with R_{f}²═(CF₂)₂ₙ and X═X12;
P-II-13: copolymer of formula (II) with R_{f}²═(CF₂)₂ₙ and X═X13;
P-II-14: copolymer of formula (II) with R_{f}²═(CF₂)₂ₙ and X═X14;
P-II-15: copolymer of formula (II) with R_{f}²═(CF₂)₂ₙ and X═X15;
P-II-16: copolymer of formula (II) with R_{f}²═(CF₂)₂ₙ and X═X16;
P-IIIa-1: copolymer of formula (IIIa) with X═X1;
P-IIIa-2: copolymer of formula (IIIa) with X═X2;
P-IIIa-3: copolymer of formula (IIIa) with X═X3;
P-IIIa-4: copolymer of formula (IIIa) with X═X4;
P-IIIa-5: copolymer of formula (IIIa) with X═X5;
P-IIIa-6: copolymer of formula (IIIa) with X═X6;
P-IIIa-7: copolymer of formula (IIIa) with X═X7;
P-IIIa-8: copolymer of formula (IIIa) with X═X8;
P-IIIa-9: copolymer of formula (IIIa) with X═X9;
P-IIIa-10: copolymer of formula (IIIa) with X═X10;
P-IIIa-11: copolymer of formula (IIIa) with X═X11;
P-IIIa-12: copolymer of formula (IIIa) with X═X12;
P-IIIa-13: copolymer of formula (IIIa) with X═X13;
P-IIIa-13: copolymer of formula (IIIa) with X═X13;
P-IIIa-14: copolymer of formula (IIIa) with X═X14;
P-IIIa-15: copolymer of formula (IIIa) with X═X15;
P-IIIa-16: copolymer of formula (IIIa) with X═X16;
P-IIIb-1: copolymer of formula (IIIb) with X═X1;
P-IIIb-2: copolymer of formula (IIIb) with X═X2;
P-IIIb-3: copolymer of formula (IIIb) with X═X3;
P-IIIb-4: copolymer of formula (IIIb) with X═X4;
P-IIIb-5: copolymer of formula (IIIb) with X═X5;
P-IIIb-6: copolymer of formula (IIIb) with X═X6;
P-IIIb-7: copolymer of formula (IIIb) with X═X7;
P-IIIb-8: copolymer of formula (IIIb) with X═X8;
P-IIIb-9: copolymer of formula (IIIb) with X═X9;
P-IIIb-10: copolymer of formula (IIIb) with X═X10;
P-IIIb-1: copolymer of formula (IIIb) with X═X11;
P-IIIb-12: copolymer of formula (IIIb) with X═X12;
P-IIIb-13: copolymer of formula (IIIb) with X═X13;
P-IIIb-14: copolymer of formula (IIIb) with X═X14;
P-IIIb-15: copolymer of formula (IIIb) with X═X15;
P-IIIb-16: copolymer of formula (IIIb) with X═X16;
P-IIIc-1: copolymer of formula (IIIc) with X═X1;
P-IIIc-2: copolymer of formula (IIIc) with X═X2;
P-IIIc-3: copolymer of formula (IIIc) with X═X3;
P-IIIc-4: copolymer of formula (IIIc) with X═X4;
P-IIIc-5: copolymer of formula (IIIc) with X═X5;
P-IIIc-6: copolymer of formula (IIIc) with X═X6;
P-IIIc-7: copolymer of formula (IIIc) with X═X7;
P-IIIc-8: copolymer of formula (IIIc) with X═X8;
P-IIIc-9: copolymer of formula (IIIc) with X═X9;
P-IIIc-10: copolymer of formula (IIIc) with X═X10;
P-IIIc-11: copolymer of formula (IIIc) with X═X11;
P-IIIc-12: copolymer of formula (IIIc) with X═X12;
P-IIIc-13: copolymer of formula (IIIc) with X═X13;
P-IIIc-14: copolymer of formula (IIIc) with X═X14;
P-IIIc-15: copolymer of formula (IIIc) with X═X15;
P-IIIc-16: copolymer of formula (IIIc) with X═X16;
P-IIId-1: copolymer of formula (IIId) with X═X1;
P-IIId-2: copolymer of formula (IIId) with X═X2;
P-IIId-3: copolymer of formula (IIId) with X═X3;
P-IIId-4: copolymer of formula (IIId) with X═X4;
P-IIId-5: copolymer of formula (IIId) with X═X5;
P-IIId-6: copolymer of formula (IIId) with X═X6;
P-IIId-7: copolymer of formula (IIId) with X═X7;
P-IIId-8: copolymer of formula (IIId) with X═X8;
P-IIId-9: copolymer of formula (IIId) with X═X9;
P-IIId-10: copolymer of formula (IIId) with X═X10;
P-IIId-11: copolymer of formula (IIId) with X═X11;
P-IIId-12: copolymer of formula (IIId) with X═X12;
P-IIId-13: copolymer of formula (IIId) with X═X13;
P-IIId-14: copolymer of formula (IIId) with X═X14;
P-IIId-15: copolymer of formula (IIId) with X═X15;
P-IIId-16: copolymer of formula (IIId) with X═X16;
P-IIIe-1: copolymer of formula (IIIe) with X═X1;
P-IIIe-2: copolymer of formula (IIIe) with X═X2;
P-IIIe-3: copolymer of formula (IIIe) with X═X3;
P-IIIe-4: copolymer of formula (IIIe) with X═X4;
P-IIIe-5: copolymer of formula (IIIe) with X═X5;
P-IIIe-6: copolymer of formula (IIIe) with X═X6;
P-IIIe-7: copolymer of formula (IIIe) with X═X7;
P-IIIe-8: copolymer of formula (IIIe) with X═X8;
P-IIIe-9: copolymer of formula (IIIe) with X═X9;
P-IIIe-10: copolymer of formula (IIIe) with X═X10;
P-IIIe-11: copolymer of formula (IIIe) with X═X11;
P-IIIe-12: copolymer of formula (IIIe) with X═X12;
P-IIIe-13: copolymer of formula (IIIe) with X═X13;
P-IIIe-14: copolymer of formula (IIIe) with X═X14;
P-IIIe-15: copolymer of formula (IIIe) with X═X15;
P-IIIe-16: copolymer of formula (IIIe) with X═X16;
P-IIIf-1: copolymer of formula (IIIf) with X═X1;
P-IIIf-2: copolymer of formula (IIIf) with X═X2;
P-IIIf-3: copolymer of formula (IIIf) with X═X3;
P-IIIf-4: copolymer of formula (IIIf) with X═X4;
P-IIIf-5: copolymer of formula (IIIf) with X═X5;
P-IIIf-6: copolymer of formula (IIIf) with X═X6;
P-IIIf-7: copolymer of formula (IIIf) with X═X7;
P-IIIf-8: copolymer of formula (IIIf) with X═X8;
P-IIIf-9: copolymer of formula (IIIf) with X═X9;
P-IIIf-10: copolymer of formula (IIIf) with X═X10;
P-IIIf-11: copolymer of formula (IIIf) with X═X11;
P-IIIf-12: copolymer of formula (IIIf) with X═X12;
P-IIIf-13: copolymer of formula (IIIf) with X═X13;
P-IIIf-14: copolymer of formula (IIIf) with X═X14;
P-IIIf-15: copolymer of formula (IIIf) with X═X15;
P-IIIf-16: copolymer of formula (IIIf) with X═X16;
P-IIIg-1: copolymer of formula (IIIg) with X═X1;
P-IIIg-2: copolymer of formula (IIIg) with X═X2;
P-IIIg-3: copolymer of formula (IIIg) with X═X3;
P-IIIg-4: copolymer of formula (IIIg) with X═X4;
P-IIIg-5: copolymer of formula (IIIg) with X═X5;
P-IIIg-6: copolymer of formula (IIIg) with X═X6;
P-IIIg-7: copolymer of formula (IIIg) with X═X7;
P-IIIg-8: copolymer of formula (IIIg) with X═X8;
P-IIIg-9: copolymer of formula (IIIg) with X═X9;
P-IIIg-10: copolymer of formula (IIIg) with X═X10;
P-IIIg-1: copolymer of formula (IIIg) with X═X11;
P-IIIg-12: copolymer of formula (IIIg) with X═X12;
P-IIIg-13: copolymer of formula (IIIg) with X═X13;
P-IIIg-14: copolymer of formula (IIIg) with X═X14;
P-IIIg-15: copolymer of formula (IIIg) with X═X15;
P-IIIg-16: copolymer of formula (IIIg) with X═X16;
P-IIIh-1: copolymer of formula (IIIh) with X═X1;
P-IIIh-2: copolymer of formula (IIIh) with X═X2;
P-IIIh-3: copolymer of formula (IIIh) with X═X3;
P-IIIh-4: copolymer of formula (IIIh) with X═X4;
P-IIIh-5: copolymer of formula (IIIh) with X═X5;
P-IIIh-6: copolymer of formula (IIIh) with X═X6;
P-IIIh-7: copolymer of formula (IIIh) with X═X7;
P-IIIh-8: copolymer of formula (IIIh) with X═X8;
P-IIIh-9: copolymer of formula (IIIh) with X═X9;
P-IIIh-10: copolymer of formula (IIIh) with X═X10;
P-IIIh-11: copolymer of formula (IIIh) with X═X11;
P-IIIh-12: copolymer of formula (IIIh) with X═X12;
P-IIIh-13: copolymer of formula (IIIh) with X═X13;
P-IIIh-14: copolymer of formula (IIIh) with X═X14;
P-IIIh-15: copolymer of formula (IIIh) with X═X15;
P-IIIh-16: copolymer of formula (IIIh) with X═X16;
P-IVa-1: copolymer of formula (IVa) with X═X1;
P-IVa-2: copolymer of formula (IVa) with X═X2;
P-IVa-3: copolymer of formula (IVa) with X═X3;
P-IVa-4: copolymer of formula (IVa) with X═X4;
P-IVa-5: copolymer of formula (IVa) with X═X5;
P-IVa-6: copolymer of formula (IVa) with X═X6;
P-IVa-7: copolymer of formula (IVa) with X═X7;
P-IVa-8: copolymer of formula (IVa) with X═X8;
P-IVa-9: copolymer of formula (IVa) with X═X9;
P-IVa-10: copolymer of formula (IVa) with X═X10;
P-IVa-11: copolymer of formula (IVa) with X═X11;
P-IVa-12: copolymer of formula (IVa) with X═X12;
P-IVa-13: copolymer of formula (IVa) with X═X13;
P-IVa-14: copolymer of formula (IVa) with X═X14;
P-IVa-15: copolymer of formula (IVa) with X═X15;
P-IVa-16: copolymer of formula (IVa) with X═X16;
P-IVb-1: copolymer of formula (IVb) with X═X1;
P-IVb-2: copolymer of formula (IVb) with X═X2;
P-IVb-3: copolymer of formula (IVb) with X═X3;
P-IVb-4: copolymer of formula (IVb) with X═X4;
P-IVb-5: copolymer of formula (IVb) with X═X5;
P-IVb-6: copolymer of formula (IVb) with X═X6;
P-IVb-7: copolymer of formula (IVb) with X═X7;
P-IVb-8: copolymer of formula (IVb) with X═X8;
P-IVb-9: copolymer of formula (IVb) with X═X9;
P-IVb-10: copolymer of formula (IVb) with X═X10;
P-IVb-11: copolymer of formula (IVb) with X═X11;
P-IVb-12: copolymer of formula (IVb) with X═X12;
P-IVb-13: copolymer of formula (IVb) with X═X13;
P-IVb-13: copolymer of formula (IVb) with X═X13;
P-IVb-14: copolymer of formula (IVb) with X═X14;
P-IVb-15: copolymer of formula (IVb) with X═X15;
P-IVb-16: copolymer of formula (IVb) with X═X16;
P-IVc-1: copolymer of formula (IVc) with X═X1;
P-IVc-2: copolymer of formula (IVc) with X═X2;
P-IVc-3: copolymer of formula (IVc) with X═X3;
P-IVc-4: copolymer of formula (IVc) with X═X4;
P-IVc-5: copolymer of formula (IVc) with X═X5;
P-IVc-6: copolymer of formula (IVc) with X═X6;
P-IVc-7: copolymer of formula (IVc) with X═X7;
P-IVc-8: copolymer of formula (IVc) with X═X8;
P-IVc-9: copolymer of formula (IVc) with X═X9;
P-IVc-10: copolymer of formula (IVc) with X═X10;
P-IVc-11: copolymer of formula (IVc) with X═X11;
P-IVc-12: copolymer of formula (IVc) with X═X12;
P-IVc-13: copolymer of formula (IVc) with X═X13;
P-IVc-13: copolymer of formula (IVc) with X═X13;
P-IVc-14: copolymer of formula (IVc) with X═X14;
P-IVc-15: copolymer of formula (IVc) with X═X15;
P-IVc-16: copolymer of formula (IVc) with X═X16;
P-IVd-1: copolymer of formula (IVd) with X═X1;
P-IVd-2: copolymer of formula (IVd) with X═X2;
P-IVd-3: copolymer of formula (IVd) with X═X3;
P-IVd-4: copolymer of formula (IVd) with X═X4;
P-IVd-5: copolymer of formula (IVd) with X═X5;
P-IVd-6: copolymer of formula (IVd) with X═X6;
P-IVd-7: copolymer of formula (IVd) with X═X7;
P-IVd-8: copolymer of formula (IVd) with X═X8;
P-IVd-9: copolymer of formula (IVd) with X═X9;
P-IVd-10: copolymer of formula (IVd) with X═X10;
P-IVd-11: copolymer of formula (IVd) with X═X11;
P-IVd-12: copolymer of formula (IVd) with X═X12;
P-IVd-13: copolymer of formula (IVd) with X═X13;
P-IVd-14: copolymer of formula (IVd) with X═X14;
P-IVd-15: copolymer of formula (IVd) with X═X15;
P-IVd-16: copolymer of formula (IVd) with X═X16;
P-IVe-1: copolymer of formula (IVe) with X═X1;
P-IVe-2: copolymer of formula (IVe) with X═X2;
P-IVe-3: copolymer of formula (IVe) with X═X3;
P-IVe-4: copolymer of formula (IVe) with X═X4;
P-IVe-5: copolymer of formula (IVe) with X═X5;
P-IVe-6: copolymer of formula (IVe) with X═X6;
P-IVe-7: copolymer of formula (IVe) with X═X7;
P-IVe-8: copolymer of formula (IVe) with X═X8;
P-IVe-9: copolymer of formula (IVe) with X═X9;
P-IVe-10: copolymer of formula (IVe) with X═X10;
P-IVe-11: copolymer of formula (We) with X═X11;
P-IVe-12: copolymer of formula (IVe) with X═X12;
P-IVe-13: copolymer of formula (IVe) with X═X13;
P-IVe-14: copolymer of formula (IVe) with X═X14;
P-IVe-15: copolymer of formula (IVe) with X═X15;
P-IVe-16: copolymer of formula (IVe) with X═X16.

### Use of the Copolymers of the Invention

By virtue of their end functions, the copolymers according to the invention make it possible to manufacture more complex polymers, of higher molar mass, or crosslinked networks.

For example, the acrylate or methacrylate end groups make it possible to manufacture crosslinked copolymers by exposing the copolymers of the invention to free radicals. The source of free radicals may be, for example, a photoinitiator (initiator sensitive to UV radiation) or the thermal decomposition of an organic peroxide. Examples of photoinitiators are the compounds Darocur® 1173, Irgacure® 819 and Irgacure® 807 from Ciba Specialty Chemicals. t-Butyl peroxypivalate is an example of a suitable organic peroxide. The copolymers of the invention, the source of free radicals and optionally fillers (carbon black, fluoropolymer powders, mineral fillers, etc.), dyes and other adjuvants may be mixed together, and the crosslinking initiated by exposure to UV radiation or to heat, depending on the case.

Similarly, the copolymers according to the invention bearing amine end groups may be used to manufacture 1) polyamides, in a manner known per se, or 2) polyurethanes from bis(cyclocarbonate) telechelic products (and advantageously relative to isocyanate reagents), or 3) epoxy resins.

Similarly, the copolymers according to the invention bearing azide end groups may be used to perform polycondensation, crosslinking or polyaddition reactions with alkynes or cyano derivatives.

Similarly, the copolymers according to the invention bearing trialkoxysilane end groups may be used to perform crosslinking reactions via a sol-gel process by acid activation (such as hydrochloric, sulfonic or methanesulfonic acid).

### EXAMPLES

The following examples illustrate the invention without limiting it.

### Example 1—Materials and Methods

The nature and origin of the products used are as follows:
tert-butyl peroxypivalate (TBPPI), tert-amyl peroxypivalate, bis(tert-butylcyclohexyl) peroxydicarbonate: Akzo Nobel (Compiégne, France);
VDF and 1234yf (Arkema);
1,1,1,3,3-pentafluorobutane (C₄F₅H+): Solvay Fluor (Tavaux, France);
1-iodoperfluorohexane (C₆F₁₃I) (99% pure): Elf Atochem; the product is treated with sodium thiosulfate, dried over magnesium sulfate and then distilled before use;
1,6-diiodoperfluorohexane (Fluorochem);
potassium persulfate K₂S₂O₈ (99% pure), allyl alcohol, tributyltin hydride (Bu₃SnH), azobisisobutyronitrile (AIBN), dimethyl carbonate (DMC), pentane, acetone (analytical grade), acetonitrile (analytical grade), methanol (analytical grade), methyl ethyl ketone (MEK), tetrahydrofuran (THF, analytical grade) and calcium hydride (99% pure powder): Sigma-Aldrich (Saint Quentin-Fallavier, France);
deuterated solvents: Euriso-top (Grenoble, France) (purity greater than 99.8%).

Characterization by nuclear magnetic resonance (NMR): the NMR spectra are recorded on a Brüker AC 400 machine. Deuterated chloroform, d6-N,N-dimethyl sulfoxide and d6-acetone are used as solvents. Tetramethylsilane (TMS) or CFCl₃ are used as references for the 1H and 19F nuclei. The coupling constants and the chemical shifts are given, respectively, in Hz and in ppm. The experimental conditions for recording the ¹H and ¹³C (or, respectively, ¹⁹F) spectra are the following: tilt angle of 90° (or, respectively, 300), acquisition time of 4.5 s (or, respectively, 0.7 s), pulse delay of 2 s (or, respectively, 2 s), 128 scans (or, respectively, 512), and pulse width of 5 s for ¹⁹F NMR.

Characterization by Fourier transform infrared spectroscopy: the measurements are taken on a Thermoscientific Nicolet 6700 FT-IR machine with a spectral range of 400-4000 cm⁻¹ with an error of ±2 cm⁻¹.

Size exclusion chromatography: the size exclusion chromatograms (SEC) or gel permeation chromatograms (GPC) are obtained with a GPC 50 multi-detection machine from Agilent Technologies with its software (Cirrus). Two PL1113-6300 ResiPore 300×7.5 mm columns are used (200<Mw<20 000 000 g·mol⁻¹) with THF as eluent, with a flow rate of 1.0 mL·min⁻¹ at room temperature. Viscometric capillary detectors are used (PL0390-06034), with a refractive index (390-LC PL0390-0601), and light scattering (PL0390-0605390 LC, with two scattering angles: 150 and 90°). Calibration is performed either with polystyrene or with polymethyl methacrylate (PMMA) standards if the copolymers contain a high proportion of VDF and, in this second case, the eluent used is DMF. The sample concentration is about 1% by mass.

Thermogravimetric analyses: the thermogravimetric analyses (TGA) are performed on a TGA 105 51 machine from TA Instruments, in air, with a heating rate of 10° C.·min⁻¹ from room temperature up to a maximum of 550° C. The sample mass is from 10 to 15 mg.

Differential scanning calorimetry: the differential scanning calorimetry (DSC) analyses are performed on a Netzsch 200F3 machine equipped with the Proteus software, under a nitrogen atmosphere, with a heating rate of 20° C./min. The temperature range is from −50 to +200° C. The system is temperature-calibrated using indium and n-hexane. The sample mass is about 10 mg. The second passage leads to a glass transition temperature defined as being the point of inflection in the increase in calorific capacity, whereas the melting point is determined by the maximum of the exothermic signal.

Autoclave: the reactions are performed in a Hastelloy Parr 160 mL autoclave (HC 276), equipped with a manometer, a Hastelloy mechanical anchor, a rupture disk (3000 psi) and inlet and outlet valves. An electronic device regulates and controls the stirring and heating. Before the reaction, the autoclave is placed under pressure with 30 bar of nitrogen to check for any leaks. The autoclave is then conditioned under vacuum (10⁻² mbar) for 40 minutes to remove any trace of oxygen. The liquid phases (with dissolved solids) are introduced via a funnel, and the gases (1234yf and then VDF) are then transferred with double weighing (measurement of the weight difference before and after the introduction of the gases into the autoclave). The reaction mixture is then stirred mechanically and heated at 74° C. or 80° C. for at least 4-6 hours. After the reaction, the autoclave is cooled in ice and degassed to release the unreacted gases. After opening the autoclave, the product is dissolved in acetone, concentrated on a rotary evaporator, precipitated from cold pentane (or water) and filtered off. If need be, a second precipitation is performed. The product is then dried under vacuum (10 mbar) at 60° C. for 12 hours to constant weight and then characterized by SEC and ¹H and ¹⁹F NMR spectroscopy.

### Example 2—Preparation of the Iodo Poly(VDF-Co-1234yf) Copolymer

K₂S₂O₈ (0.022 mol, 6.012 g), C₆F₁₃I (0.0336 mol, 15.02 g) and demineralized water (60.0 g) are introduced into the autoclave; 1234yf (0.039138 mol, 4.5 g) and VDF (0.3438 mol, 22.00 g) are then added. The autoclave is heated to 80° C., following a heating profile with 5-minute equilibria at 30, 40, 50, 60 and 70° C. A small exotherm of about 5° C. (leading to a maximum pressure Pmax of 63 bar) is observed, followed by a pressure drop to 58 bar. After reaction for 14 hours, the autoclave is placed in an ice bath for about 60 minutes, and the unreacted VDF and 1234yf are released. After opening the autoclave, the product is extracted with MEK and then precipitated from ice-cold pentane, filtered off and dried under vacuum. A white powder (20.7 g) is obtained in a yield of 78-80%. The poly(VDF-co-1234yf) copolymer is soluble in various polar solvents, such as acetone, DMF, THF, MEK and DMSO.

In certain variants, TBPPI is used instead of K₂S₂O₈ as initiator, and the concentrations of VDF, 1234yf, initiator and iodo agent are modified. The table below summarizes the tests performed and the results obtained:

| | Test 1 | Test 2 | Test 3 | Test 4 | Test 5 |
|---|---|---|---|---|---|
| Type of process | solution | solution | solution | emulsion | emulsion |
| Content of VDF in | 80 | 80 | 75 | 90 | 84 |
| gaseous mixture (mol %) | | | | | |
| Content of 1234yf in | 20 | 20 | 25 | 10 | 16 |
| gaseous mixture (mol %) | | | | | |
| Content of C₆F₁₃I (mol %) | 5 | 13 | 25 | 36 | 16 |
| Initiator (mol %) | TBPPI | TBPPI | TBPPI | K₂S₂O₈ | K₂S₂O₈ |
| | (5) | (5) | (10) | (5) | (5) |
| Yield (%) | 72 | 75 | 77 | 78 | 80 |
| Content of VDF in the | 67 | 72 | 69 | 86 | 71 |
| copolymer (mol %) | | | | | |
| Content of 1234yf in the | 33 | 28 | 31 | 14 | 29 |
| copolymer | | | | | |
| CF₂I end groups in the | 0 | 0 | 0 | 3 | 22 |
| copolymer (%) | | | | | |
| CH₂I end groups in the | 0 | 0 | 0 | 25 | 8 |
| copolymer (%) | | | | | |
| CFCF₃I end groups in the | 0 | 0 | 0 | 7 | 6 |
| copolymer (%) | | | | | |
| Number-average molar | 3900 | 4100 | 2600 | 2300 | 4900 |
| mass of the copolymer (g/mol) | | | | | |
| Polydispersity index | 1.68 | 1.32 | 1.33 | 1.32 | 1.68 |
| Degradation temperature (° C.) | 360 | 365 | 290 | 300 | 195 |
| Glass transition | −18 | −20 | −26 | −27 | −25 |
| temperature (° C.) | | | | | |
| Melting point (° C.) | 126 | 115 | 121 | 100 | 117 |
| Crystallization temperature (° C.) | 106 | 40 | 71 | 79 | 90 |

In the above table, the composition of the copolymer is determined by NMR, the molar mass is determined by SEC calibrated with PS or PMMA (which also makes it possible to determine the polydispersity index), the degradation temperature (10%) is determined by TGA in air, at 10° C./min, and the glass transition temperature, melting point and crystallization temperature are determined by DSC.

The ¹⁹F NMR spectrum of the copolymer of test 5 is illustrated in FIG. 1. The IR spectrum of this copolymer is illustrated in FIG. 2.

### Example 3—Preparation of Bis(Iodohydrin)-Functionalized P(VDF-Co-1234yf)

The diiodo poly(VDF-co-1234yf) oligomer of example 2 (5.0 g, 8.0 mmol), allyl alcohol (2.78 g, 47.8 mmol) and dry acetonitrile (50 mL) are placed in a 100 mL two-necked round-bottomed flask equipped with a condenser and a magnetic stirrer. The flask is heated to 80° C. AIBN (0.262 g, 1.6 mmol) is added in 10 doses (26 mg each) with an interval of 45 minutes between the additions. The reaction is performed under a nitrogen atmosphere at 80° C. over about 20 hours. After cooling to room temperature, the reaction mixture is filtered through cotton wool and the excess solvent is removed on a rotary evaporator (40° C./20 mmHg). A viscous yellowish liquid is obtained, which is dried (40° C./0.01 mbar) to constant weight. The bis(iodohydrin) telechelic poly(VDF-co-1234yf) copolymer is obtained in a yield of 90%.

A similar reaction is performed with undecylenol instead of allyl alcohol, and gives a bis(iodo) telechelic poly(VDF-co-1234yf) macrodiol.

### Example 5—Preparation of Diol-Functionalized P(VDF-Co-1234yf)

The bis(iodohydrin) P(VDF-co-1234yf) of example 3 (3.50 g, 0.85 mmol), tributyltin hydride (4.48 g, 15.37 mmol) and acetonitrile (50 mL) are placed in a 250 mL three-necked round-bottomed flask equipped with a condenser and a magnetic stirrer. The flask is heated to 70° C. AIBN (0.50 g, 3.003 mmol) is added in 10 doses with an interval of 60 minutes between the additions. The reaction is performed under a nitrogen atmosphere at 70° C. for 10 hours. After cooling to room temperature, KF (0.61 g, 10 mmol) is added with 50 mL of diethyl ether. The mixture is then stirred at room temperature for 24 hours. The mixture is filtered to remove the solids such as Bu₃SnK, Bu₃SnF and Bu₃SnI. The solvents are removed on a rotary evaporator (40° C./20 mmHg) and the crude product is dissolved in 50 mL of 2-butanone and then washed with water (2×50 mL). The organic layer is dried over MgSO₄ and then filtered. The 2-butanone is partly removed on a rotary evaporator and the residue is precipitated from cold pentane. The mixture is stored at 4° C. for 12 hours and the pentane is then decanted from the precipitate. The remaining solvent is evaporated off under vacuum and the viscous yellowish liquid obtained is dried (40° C./0.01 mbar) to constant weight. The product is obtained in an overall yield of 82%.

The NMR and IR spectra of this copolymer are illustrated in FIGS. 3, 4 and 5.

1. A copolymer comprising:
one or more polymer chains comprising vinylidene fluoride and tetrafluoropropene units; and
one or more functional end groups comprising at least one alcohol, acetate, vinyl, azide, amine, carboxylic acid, (meth)acrylate, epoxide, cyclocarbonate, alkoxysilane or vinyl ether function.

2. The copolymer as claimed in claim 1, in which said polymer chains comprise vinylidene fluoride and 2,3,3,3-tetrafluoropropene units.

3. The copolymer as claimed in claim 1, in which said polymer chains are statistical polymer chains.

4. The copolymer as claimed in claim 1, in which each said polymer chain has a number-average molar mass of from 500 to 300,000 g/mol.

5. The copolymer as claimed in claim 1, in which the functional end group(s) are selected from the group consisting of:
—CH₂—CHI—CH₂—OH,
—CH₂—CHI—CH₂—OAc, in which OAc represents an acetate function,
CH₂—CH₂—(CH₂)ₘ—OH, in which m is an integer from 0 to 10,
CH₂—CH₂—(CH₂)ₘ—O—C(═O)—CH═CH₂ in which m is an integer from 0 to 9,
—CH₂—CH₂—(CH₂)ₘ—O—C(═O)—C(CH₃)═CH₂, in which m is an integer from 0 to 9,
—CH₂—CH₂—N₃,
—CH₂—CH₂—NH₂,
—CH₂—COOH,
(CH₂)—CH═CH₂,
—O—CH═CH₂,
—Si(OR)ₓ(CH₃)₃₋ₓ, x being an integer from 1 to 3, and each R independently representing an alkyl group comprising from 1 to 10 carbon atoms;
—O—CH₂-epoxide; and
—O—CH₂-cyclocarbonate.

6. The copolymer as claimed in claim 1, which is a linear copolymer of formula (I) R_{f}¹-A-X, in which X is a functional end group, A is a polymer chain and R_{f}¹ represents a halogenated end group.

7. The copolymer as claimed in claim 6, in which Rf¹ represents a fluoroalkyl chain F—(CF₂)₂ₙ, n representing an integer from 1 to 6.

8. The copolymer as claimed in claim 1, which is a linear copolymer of formula (II) X-A-R_{f}²-A′-X, in which each X represents a functional end group, A and A′ each represent a polymer chain and R_{f}² represents a halogenated bonding group.

9. The copolymer as claimed in claim 8, in which Rf² represents a fluoroalkylene chain (CF₂)₂ₙ, n representing an integer from 1 to 6.

10. The copolymer as claimed in claim 8, in which Rf² represents B—R_{f}′—B′, with R_{f}′ a fluoro alkylene chain (CF₂)₂ₙ, n representing an integer from 1 to 6, and B and B′ each representing a copolymer chain composed of halogenated units.

11. The copolymer as claimed in claim 10, in which B and B′ each represent a copolymer chain composed of halogenated units derived from one or more monomers of formula CY₁Y₂═CY₃Y₄, in which Y₁, Y₂, Y₃ and Y₄ are chosen from H, F, Cl, Br, CF₃, C₂F₅ and C₃F₇, at least one of them being a fluorine atom.

12. The copolymer as claimed in claim 10, in which B and B′ each represent a polymer chain composed of units chosen from units derived from vinylidene fluoride, trifluoroethylene, tetrafluoroethylene, 2,3,3,3-tetrafluoropropene, vinyl fluoride, 2-chloro-1,1-difluoroethylene, chlorofluoro-1,1-ethylene, chlorofluoro-1,2-ethylene, chlorotrifluoroethylene, 2-bromo-1,1-difluoroethylene, hexafluoropropene, 3,3,3-trifluoropropene, 3,3,3-trifluoro-2-chloropropene, 1,3,3,3-tetrafluoropropene, 3,3,3-trifluoro-2-bromopropene, 1H-pentafluoropropene, 3,3,3-trifluoro-1-chloropropene, bromotrifluoroethylene and 2H-pentafluoropropene monomers.

13. The copolymer as claimed in claim 10, in which B and B′ each have a number-average molar mass of from 500 to 300,000 g/mol.

14. The copolymer as claimed in claim 1, which is a star copolymer of formula: 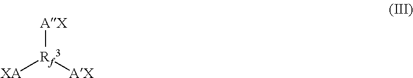
in which each X represents a functional end group, A and A′ each represent a polymer chain, and R_{f}³ represents a halogenated bonding group.

15. The copolymer as claimed in claim 14, which is a copolymer having one of the formulae (IIIa) to (IIIh): 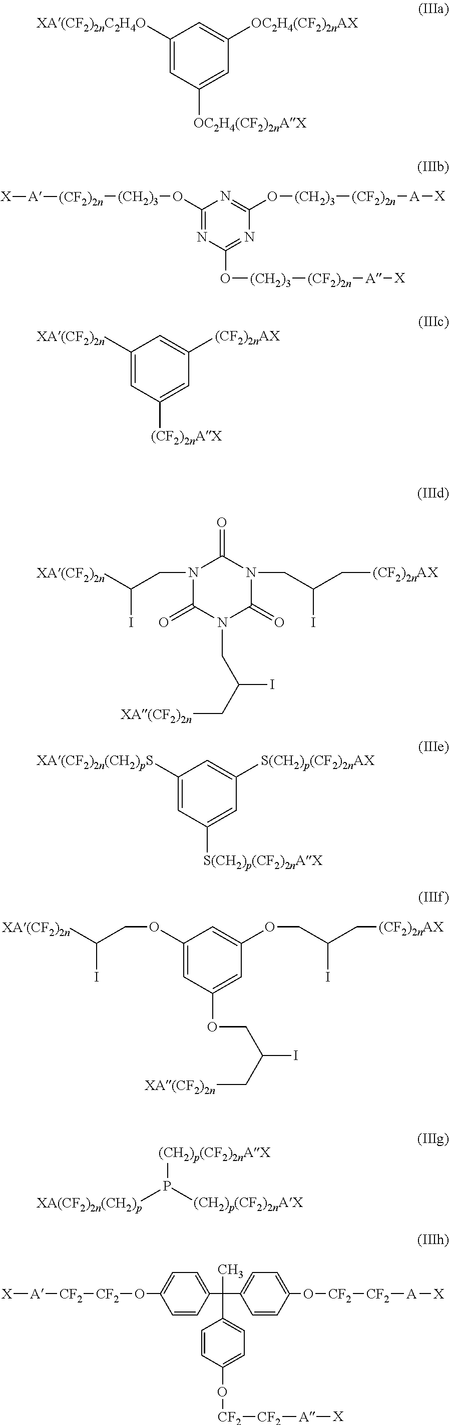
in which n is an integer from 1 to 6 and p is an integer equal to 1 or 2.

16. The copolymer as claimed in claim 1, which is a star copolymer of formula: 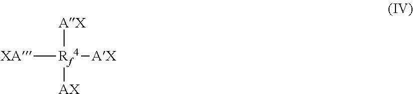
in which each X represents a functional end group A and A′ each represent a polymer chain, and R_{f}⁴ represents a halogenated bonding group.

17. The copolymer as claimed in claim 16, which is a copolymer having one of the following formulae:

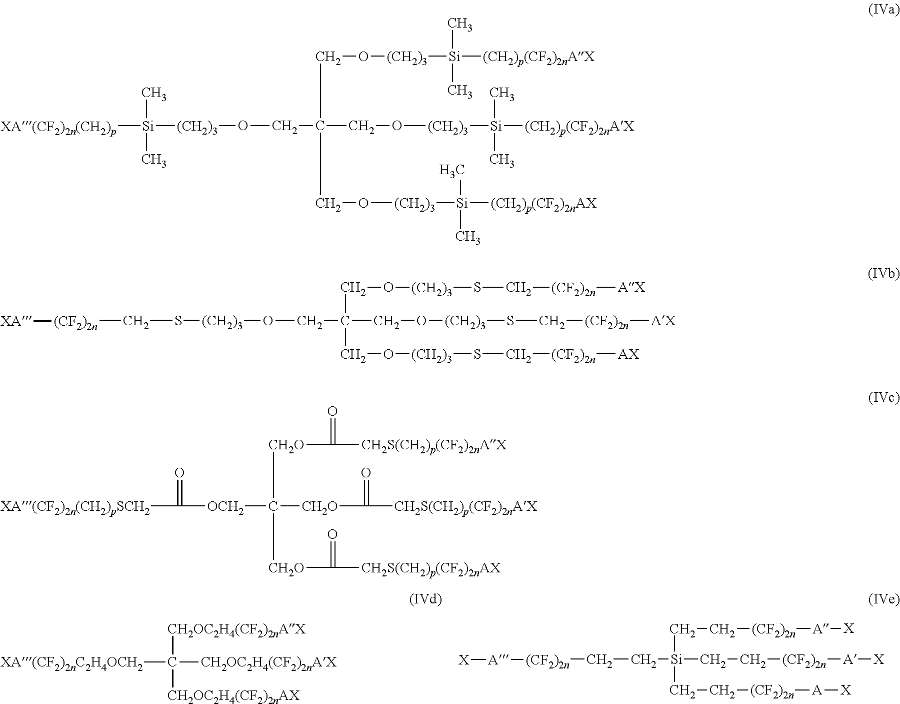

18. A process for preparing a copolymer as claimed in claim 1, comprising:
a step of providing a copolymer comprising one or more polymer chains comprising vinylidene fluoride and tetrafluoropropene units, and also one or more iodo end groups; and
a step of functionalizing one or more of said iodo end groups.

19. The process as claimed in claim 18, in which said step of providing said copolymer comprises a step of controlled radical copolymerization of a vinylidene fluoride monomer and of a tetrafluoropropene monomer, in the presence of an initiator and of an iodo compound as chain-transfer agent.

20. The process as claimed in claim 19, in which the chain-transfer agent is chosen from the compounds of formulae:
F—(CF₂)₂ₙ—I,
CH₂═CH—(CF₂)₂ₙ—I,
CH₂═CH—CH₂—(CF₂)₂ₙ—I,
I—CH₂—CH₂—(CF₂)₂ₙ—I,
I—(CF₂)₂ₙ—I,
I—B—(CF₂)₂ₙ—B′—I, B and B′ each representing a copolymer chain composed of halogenated units,
the compound of formula (IIIa′): 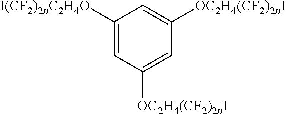
the compound of formula (IIIb′): 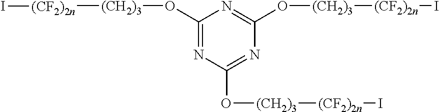
the compound of formula (IIIc′): 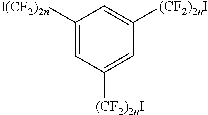
the compound of formula (IIId′): 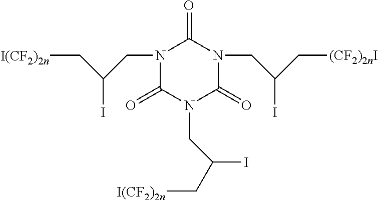
the compound of formula (IIIe′): 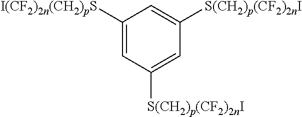
the compound of formula (IIIf′): 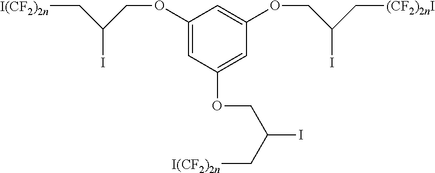
the compound of formula (IIIg′): 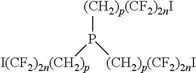
the compound of formula (IIIh′): 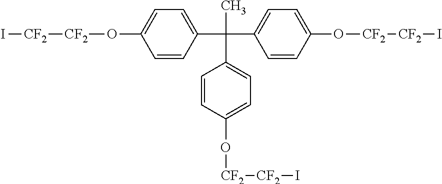
the compound of formula (IVa′): 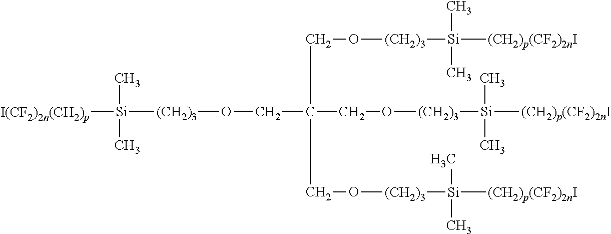
the compound of formula (IVb′): 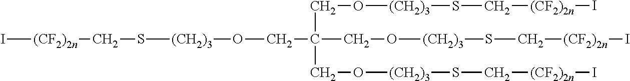
the compound of formula (IVc′): 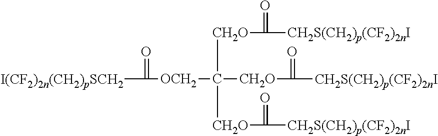
the compound of formula (IVd′): 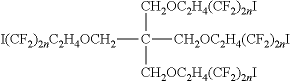
the compound of formula (IVe′): 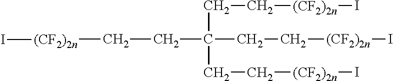
in which n represents an integer from 1 to 6 and p represents an integer equal to 2 or 3.

21. The process as claimed in claim 20, in which the chain-transfer agent chosen from the compounds of formulae I—B—(CF₂)₂ₙ—B′—I, B and B′ each representing a copolymer chain composed of halogenated units, is a copolymer chain composed of two halogenated units derived from one or more monomers of formula CY₁Y₂═CY₃Y₄, in which Y₁, Y₂, Y₃ and Y₄ are chosen from H, F, Cl, Br, CF₃, C₂F₅ and C₃F₇, at least one of them being a fluorine atom.
